(19) United States
(12) Patent Application Publication
(10) Pub. No.: US 2007/0036832 A1
(43) Pub. Date: Feb. 15, 2007

(54) Stabilized halopropynyl compositions as preservatives

(76) Inventors: Gareth R. Williams, Middlefield, CT (US); Christina Ann Williams, York (GB); Radu Craciun, Carmel, NY (US)

Correspondence Address: KING & SPALDING LLP, 1180 PEACHTREE STREET, ATLANTA, GA, 30309-3521, US

(21) Appl. No.: 10/571,518

(22) PCT Filed: Sep. 20, 2004
(86) PCT No.: PCT/US04/30647

§ 371 Date: May 8, 2006

Related U.S. Application Data
(60) Provisional application No. 60/504,033, filed on Sep. 19, 2003.

(51) Int. Cl. B32B 21/02; A01N 25/00

(52) U.S. Cl. 424/405; 428/292.4

(57) ABSTRACT

Preservative compositions are provided with improved stability. The preservative compositions comprise a combination of an amphoteric compound and 3-iodo-2-propynyl butyl carbamate (IPBC). In a particular embodiment, the compositions comprise a combination of a betaine compound and 3-iodo-2-propynyl butyl carbamate. The compositions in some embodiments have surprising stability. The preservative composition can be used in personal care products, household products, industrial products and materials. The compositions can be used in a variety of methods for the treatment of surfaces such as cellulosic surfaces, such as wood surfaces. The compositions can be used in one embodiment to provide stain resistance to wood.

### CROSS REFERENCE TO RELATED APPLICATIONS

This application claims the benefit of U.S. Provisional Application No. 60/504,033, filed Sep. 19, 2003, the disclosure of which is incorporated herein by reference.

### TECHNICAL FIELD

This invention relates to preservative compositions comprising a halopropynyl compound derived from halopropargyl alcohols (e.g. iodopropargyl alcohols), such as 3-iodo-2-propynyl N-butyl carbamate (DPBC), and an amphoteric compound, such as a weak nitrogen amphoteric or a betaine compound.

### BACKGROUND OF THE INVENTION

Preservatives are very common in commercial and industrial products. The need for effective and economical preservative compositions is well known. There are a wide variety of applications where inhibiting the growth of microorganisms is necessary, as for example personal care products such as shampoos, conditioners, hair care products, creams, lotions, cosmetics, soap, skin care products; household products such as laundry detergents, hard surface cleaners, and fabric softeners; and industrial products and materials, such as adhesives, sizes, paper and cardboard, textiles, leather, wood, paints and articles made of plastic, cooling lubricants. The shelf life of these preparations depends on their resistance to microbial spoilage. In addition, in many industrial applications, antimicrobial agents are useful in sealants, rope, paper pump, plastics, fuel, oil, and rubber and metal working fluids and as wood preservatives. The control of slime-producing bacteria and fungi in pump and paper mills and cooling towers is a matter of substantial commercial importance.

Examples of microorganisms which can effect contamination, degradation, or a change in the industrial environment and industrial and/or commercial materials are bacteria, fungi, yeasts, algae, and slime organisms. Microorganisms of the following genera are examples: Alternaria, such as Alternaria tenuis, Aspergillus, such as Aspergillus niger, Chaetomium, such as Chaetomium globosum, Candida, such as Candida albicans, Lentinus, such as Lentinus tigrinus, Penicillium, such as Penicillium glaucum, Trichophyton, such as Trichophyton mentagrophytes, Aureobasidium, such as Aureobasidium pullulans, Enterobacter, such as Enterobacter gergoviae, Trichoderma, such as Trichoderma viride, Escherichia, such as Escherichia coli, Pseudomonas, such as Pseudomonas aeruginosa and Pseudomonas cepacia, and Staphylococcus, such as Staphylococcus aureus and Staphylococcus epidermidas.

In order to keep fungal growth and other microbial degrade in such products at an acceptable level it is conventional practice for the products to contain a preservative. Many preservatives are available. The appropriate preservative has to be selected with regard to its efficacy and, depending on its use, its acceptability to contact with human or animal skin. With regard to its acceptability there are in many countries laws and regulations governing the maximum permitted content of preservative in products intended for human use due to their possible toxic or otherwise harmful effect. Many of the antimicrobials have toxicity and/or environmental problems.

For instance, several preservative compositions are based on the presence of heavy metals in the formulation, such as copper, zinc and tin; alternatively, metal-free (organic) formulations are also used extensively. Both inorganic as well as organometallic compounds have been extensively used in wood preservation. Most common products are based on arsenic, chromium, copper, tin and zinc. Some of the earliest wood preservatives used simple zinc salts such as zinc chloride, however performance of these formulations in a wet environment proved limited. Chromium can be added to improve zinc permanence, however, may demonstrate poor performance against some of the heavy metal tolerant fungi. Zinc is used in the form of an ammoniacal-copper-zinc-arsenate formulation. Zinc has also been used extensively in light organic solvent treatments in the form of naphthenates, or the so-called zinc ‘soaps’, based on the use of branched chain carboxylic acids, such as isononanoic acid and neodecanoic acid. Copper provides approximately twice the level of activity on an equivalent weight basis. The spectrum of activity is broad, however, several organisms are known to be tolerant to copper (Williams, G. R. and Fox, R. F., The control of copper tolerant basidiomycete fungi in preservative treated wood in ground contact, Proceedings of the American Wood Preservers Association Annual Meeting, 1994). Copper-based preservatives can be formulated as organometallic, entirely inorganic, or mixtures of organic biocides and copper compounds. The copper organometallic systems include compounds such as copper naphthanate and copper-8-quinolinolate. Inorganic copper salt formulations can be based on copper, chromium and arsenic, as disclosed in Kamesan, British Patent No. GB404855 (1933).

Iodine-containing compounds provide alternative biocides to metals. Therefore, a class of compounds which have met with particular success because of their antimicrobial activity are the halopropargyl carbamates, particularly 3-iodo-2-propargyl butyl carbamate, IPBC. Processes for the preparation of such class of compounds and their use are disclosed in European Patent Application 0 014 032 (1980), and U.S. Pat. Nos. 3,660,499, 3,923,870, 4,259,350, 4,592,773, 4,616,004, 4,661,632, 4,639,541, 4,647,572, 4,719,227 and 4,945,109, all incorporated herein by reference. Unfortunately, the performance of such compounds is too restricted in some end uses due to lack of light stability and/or chemical stability to allow successful formulation in both organic solvent and water-based systems. This naturally imposes a severe limitation on the usefulness of these products.

In particular, 3-iodo-2-propargyl butyl carbamate, IPBC, is especially suitable for use as a preservative, for example in personal care products, the metalworking fluid industry for controlling bacteria and fungi, and in wood preservation (see DE-OS 2,433,410), and is manufactured and sold by Troy Chemical Company under various names such as Polyphase™ product, Polyphase™ AF-1 product, and Polyphase™ NP-1 product, as well as by Arch Chemicals, Inc. under the name OMACIDE®. IPBC is used for a wide range of applications with activity against the lower fungi as well as basidiomycetes. Further, its activity towards the former group of molds and staining fungi has focused the wood protection industries development towards its use as an antisapstain formulation and to control stain and decay on treated joinery (millwork) components. Wood preservative compositions comprising 3-iodo-2-propynyl butyl carbamate have been used against fungi that cause structural and cosmetic damage to wood. See Chemical Abstracts, Vol. 92, No. 92:75897f, Singer (1980).

It is, however, necessary to combine halopropargyl carbamates, such as IPBC, with other compounds to help stabilize the composition. For example, Troy Chemie's technical instruction sheet for Troyshield F20™ advises against mixing it with strongly alkaline bactericides, such as, for example, 1,3,5-tris(hydroxyethyl)hexahydro-triazine (Grotan BK™, because the stability of fungicidally and bactericidally active preparations based on IPBC is impaired.

There has thus been a search for potential ways of improving the stability of halopropargyl carbamate-based compositions for use as preservatives having a fungicidal and bactericidal action.

An almost white powder consisting of IPBC and a mixture of 1,3-bis(hydroxymethyl)-5,5-dimethylhydantoin and hydroxymethyl-5,5-dimethylhydantoin GlydantPlus™, Lonza AG), which has been used as a preservative for cosmetic preparations.

U.S. Pat. No. 5,496,842 and U.S. Pat. No. 5,428,050 disclose water-soluble compositions comprising a combination of iodopropynylbutyl compounds and N-methylol compounds; It is disclosed that compositions comprising IPBC and N-methylol compounds in a weight ratio of from 1:100 to 1:2000 are in the form of a concentrate powder which, as a water-soluble additive, can be added to industrial products, in particular body care products, which then include from 0.01% to 2% of these compositions. The N-methylol compounds mentioned in U.S. Pat. No. 5,496,842 and U.S. Pat. No. 5,428,050 do, however, include compounds which are not compatible with IPBC, for example 1,3,5-tris(hydroxyethyl)-hexahydrotriazine.

EP 0327220 B1 discloses a combination of an iodopropynyl compound with known formaldehyde donors. The disclosed compositions include, as the iodopropynyl compound, IPBC and, as formaldehyde donors, non-toxic and odorless compounds which are suitable for use in bodycare products, for example urea derivatives and dimethyloldimethylhydantoin. The compositions of EP 0327200 B1 are likewise added, for example, in the form of solid, water-soluble mixtures, to the products to be preserved.

U.S. Pat. No. 4,950,685 to Kop-Coat is directed to a synergistic combination of a quaternary ammonium compound and 3-iodo-2-propynyl butyl carbamate (IPBC) for providing stain resistance to wood. The Kop-Coat patent provides examples and tests to demonstrate the synergistic effect of the combination. U.S. Pat. No. 6,582,732 and PCT WO 02/13605 to Kop-Coat discloses synergistic combinations of wood preservatives to increase the insect resistance containing boron compounds in combination with synthetic pyrethroids. U.S. Pat. No. 6,416,789 to Kop-Coat discloses wood preservative combinations of boron-containing fungicides and organo-iodine compounds including IPBC.

U.S. Pat. No. 6,375,727 to Lonza, Inc., discloses blends of amine oxides and an iodine containing biocide compounds for wood preservation. U.S. Pat. No. 5,389,300 to Bayer Aktiengesellschaft discloses a composition for protecting sawn timber against wood discoloring fungi, containing a phenol fungicide and an organo-iodine fungicide, such as IPBC. U.S. Pat. Nos. 6,582,627 and 6,143,204 to Lonza, Inc. disclose formulations with antimicrobial and preservative properties that contain dimethylol-dimethylhydantoin, 3-iodo-2-propynyl-butyl carbamate, dimethylhydantoin, and a glycol solvent.

U.S. Pat. No. 5,071,479 to Troy Chemicals discloses synergistic combinations of biocides for anti-fouling paint of 3-iodo-2-propynyl-butyl carbamate, 3-iodo-2-propynyl-cyclohexyl carbamate, 3-iodo-2-propynyl phenyl carbamate, 3-iodo-2-propynylbenzyl carbamate, 3-iodo-2-propynyl propyl carbamate and 4-iodo-3-butynyl propyl carbamate and a tributyltin compound. The compositions are disclosed as being waterproof and suitable for use on aquatic vehicles.

In formulated products, the stability of IPBC is often limited in both the concentrate and dilute solution, particularly in the presence of amine. Residual amine is commonly found in products containing typical quaternary ammonium-based biocides such as alkyl dimethyl ammonium chloride (BAC) or didecyldimethyl ammonium chloride (DDAC). See, e.g., U.S. Pat. No. 4,950,685. Alkyl ammonium compounds and particularly the quaternary ammonium compounds (quats) have been used in the wood preservation industry. Two main types of quaternary ammonium compounds are often used; alkylbenzyl dimethylammonium chloride (such as benzalkonium chloride, BAC) and the dialkyldimethyl ammonium chlorides (such as didecyldimethyl ammonium chloride, DDAC). Wood preservative compositions comprising didecyldimethyl ammonium chloride as the active ingredient have used against wood damaging fungi and termites, as described e.g., in Chemical Abstracts, Vol. 87, No. 87:103500p, Butcher et al. (1987). These quaternary ammonium biocides are also surfactants and are commonly used to emulsify IPBC, while providing additional biological activity. These additives result in a formulation which can decrease the stability of IPBC.

Therefore, there is a need for compositions that have enhanced stability and preservation of the active ingredients.

Further, there is a need for wood preservative treatments that have increased stability, penetration, and solubility.

There is a need for stabilized preservative compositions containing a halopropargyl carbamate, such as IPBC.

There is also a need for stabilized combinations of IPBC, which previously were considered destabilized due to interactions within the formulation, such as IPBC with quats (quaternary ammonium compounds), or IPBC with an amine.

### SUMMARY OF THE INVENTION

Preservative compositions comprising a combination of an amphoteric compound, such as a weak nitrogen amphoteric or betaine, and a halopropargyl biocide, such as 3-iodo-2-propynyl butyl carbamate, alternatively referred to as IPBC, which has the structural formula: I—C≡C—CH₂O—C(O)—NH—(CH₂)₃—CH₃ are provided. In a particular embodiment, the compositions disclosed herein comprise a combination of a weak nitrogen amphoteric and 3-iodo-2-propynyl butyl carbamate. In another particular embodiment, the compositions disclosed herein comprise a combination of a betaine compound and 3-iodo-2-propynyl butyl carbamate. Optionally, the composition may include IPBC and a betaine compound as well as a weak nitrogen amphoteric. The compositions in some embodiments have surprising stability. The preservative composition may alternatively comprise an amphoteric compound, such as a weak nitrogen amphoteric or betaine compound, in combination with one or more biocides.

The compositions including IPBC and a betaine compound and/or a weak nitrogen amphoteric compound can include further active compounds including amines and quats that are for example biocides.

In one embodiment, preservative compositions are provided comprising a betaine compound and IPBC, and one or more additional biocides, such as propiconazole, tebuconazole, Na-omadine, or other additives, such as amine oxides.

The preservatives of the invention can be used for the preservation of cosmetics, personal care products, household products, and industrial materials such as adhesives, sizes, paper and cardboard, textiles, leather, wood, paints and articles made of plastic, cooling lubricants and other materials which can be attacked or decomposed by microbes and/or fungi. Components of production plants, for example cooling water, which can be impaired by multiplication of microbes and/or fungi, may also be treated. Also, the integrity of other water-containing systems, such as swimming pools and spas, can be maintained by use of the preservatives of the invention. In addition, they can be used to control and eliminate microbes and/or fungi by disinfection and sanitization of surfaces, such as found in homes, institutions, and hospitals.

In one embodiment, the preservative composition is used in personal care products such as shampoos, conditioners, hair care products, creams, lotions, cosmetics, soap, skin care products; or household products such as laundry detergents, hard surface cleaners, and fabric softeners. In an alternative embodiment, the preservative composition is used in industrial products and materials, such as adhesives, sizes, paper and cardboard, textiles, leather, wood, paints and articles made of plastic, cooling lubricants. In addition, in many industrial applications, the preservative composition can be used in sealants, rope, paper pump, plastics, fuel, oil, and rubber and metal working fluids and as wood preservatives. Therefore, in one embodiment, the preservative composition can be used for the treatment of materials, including cellulosic materials. In one embodiment, preservative compositions are provided having the property of providing stain resistance to wood. The preservative composition can be used in controlling the slime-producing bacteria and fungi in pump and paper mills and cooling towers.

The formulations for the control of fungi on susceptible substrates can show increased stability of IPBC in concentrate and dilute solution form. This stability can translate to biological activity when compared to reference products that are commercially available. This stability can also translate into providing a useful stable product for the treatment of wood to, e.g., enhance stain resistance.

The amphoteric group known as betaines, particularly the carboxy-betaines are useful. The formulations may be used to treat a wide variety of surfaces including wood and cellulosic substrates. The preservative compositions can be effective in wood applications in treating wood defacing fungi such as molds and stains (lower fungi), as well as wood destroying fungi such as the brown and white rots (higher fungi), and fungi causing degradation on susceptible substrates.

The betaine compound in one embodiment contains an alkyl chain with a carbon chain length of, e.g., C₆ to C₂₄ (including independently any carbon chain within these), or C₈-C₁₈, or C₁₀ to C₁₈, or, in another embodiment, C₁₂ to C₁₆.

One skilled in the art would recognize that polymers are often synthesized with a molecular weight distribution. For a particular material, it is possible to have either a narrow range (narrow cut) or broader range (broad cut). For example, a particular material could comprise 80% C₁₂ and 20% C₁₄.

The preparation of water-based emulsion concentrates of the organic fungicide IPBC is enhanced by stable concentrate products formed as described herein that can be readily diluted in water. Such formulation can be used to treat surfaces comprising (but not exclusively) wood and cellulose.

The preservative composition can be used in controlling the slime-producing bacteria and fungi in pump and paper mills and cooling towers.

In another embodiment, provided are compositions comprising IPBC in combination with an weak nitrogen amphoteric compounds and a quat (quaternary ammonium compound), such as didecyl-methyl-ammonium chloride or benzyl-alkyl-ammonium chloride or amines.

### PARTICULAR EMBODIMENTS

Exemplary embodiments of formulations are described throughout herein, wherein ratios are intended to be ratios by weight unless otherwise indicated.

In one embodiment, a fungicidal composition is provided comprising: a betaine or a weak nitrogen amphoteric compound comprising a C₁₂-C₁₆ alkyl group; and 3-iodo-2-propynyl butyl carbamate; wherein the ratio of betaine:3-iodo-2-propynyl butyl carbamate is about 3:1 to 5:1; and wherein the composition includes a secondary biocide, such as propiconazole, wherein the ratio of IPBC to biocide in the composition is about 3:2 to 1:1.

In another embodiment, the ratio of betaine: IPBC in the preservative composition is about 10:1 to 1:5; or is, e.g. about 20:1 to 1:10.

Optionally the composition may include IPBC:propiconazole in a ratio of 1:1 to 2:1.

The invention provides a preservative composition comprising an amphoteric compound and 3-iodo-2-propynyl butyl carbamate that is useful in a variety of applications. The preservative composition may comprise a betaine, such as a carboxy betaine and 3-iodo-2-propynyl butyl carbamate. The composition may be used, e.g., in a personal care product, or a household product, industrial product or material, or may be a wood preservative. The composition can have a variety of properties including providing stain resistance to wood.

The preservative composition may further comprise an additive, e.g. a biocide such as propiconazole. En the preservative composition the ratio of betaine to 3-iodo-2-propynyl butyl carbamate is e.g., 3:1 to 5:1. Further additives that can be included in the composition include antifoam agents and glycols such as those disclosed herein, as well as solvents such as water (including deionized water) and iso-propanol.

The preservative composition may include a betaine selected from the group consisting of coco amido propyl dimethyl betaine; cetyl betaine ((carboxylatomethyl)hexadecyldimethylammonium); and coco amido propyl dimethyl sultaine (cocoamidopropyl-N,N-dimethyl-N-2-hydroxypropyl sulfobetaine.

The betaine is, e.g. of the formula
R—N⁺(CH₃)₂—CH₂-COO⁻; or
R—C(═O)N⁺(CH₃)₂—CH₂—COO⁻ or

a salt thereof

where R is a straight chain C₆₋₂₄ alkyl group, or a C₁₀₋₁₈ alkyl group, or R is a straight chain C₁₂₋₁₆ alkyl group.

The betaine in one embodiment is a cocamidopropylbetaine of formula:
RC(O)NH(CH₂)₃—N⁺(CH₃)₂—CH₂—COO⁻

wherein R is a C₉ to C₁₃ straight chain alkyl group.

Also provided is a preservative composition comprising a weak nitrogen amphoteric and 3-iodo-2-propynyl butyl carbamate. The composition may be used in a personal care product, a household product, industrial product or material, and may be used as a wood preservative. The composition may have the property of providing stain resistance to wood. The weak nitrogen amphoteric may be an imidazoline amphoteric. The preservative composition may further comprise an additive, such as a biocide, such as propiconazole. The ratio of weak nitrogen amphoteric: IPBC is, e.g., 3:1 to 5:1.

The preservative composition may comprise a weak nitrogen amphoteric selected from the group consisting of cocoamphodiacetate, cocoamphoacetate, cocoamphopropionate, cocoampho-dipropionate, C₁₂₋₁₈ alkyl-amphopropionate, C₁₂ alkyliminodipropionate, coco-amphopolycarboxy-glycinate; tallowamphopolcarboxyglycinate; cocoimino-glycinate; cocoampho-carboxyglycinate; oleylamphopolycarboxyglycinate; oleyl-amphopolycarboxyglycinate; oleylamphopolycarboxyglycinate; cocoimino-propionate; and octyliminodipropionate.

The weak nitrogen amphoteric may be of the formula (I):

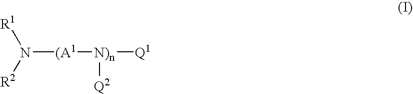

wherein
each n is independently 0-15;
each R¹ and R² is independently H, alkyl, —R³, acyl, —COR³, alkoxy, —OR³ or -Q³; wherein at most one of R¹ and R² is H and at most one of R¹ and R² is acyl, —COR³, alkoxy, or —OR³;
each R³ is independently a straight or branched alkyl chain;
each Q¹, Q², and Q³ is independently hydrogen, -(A²-COO)ₚX¹ or -(A³-O)_{q}H; wherein at least one Q¹, Q² or Q³ is independently -(A²-COO)ₚX¹;
each A¹, A², and A³ is independently a divalent straight or branched alkylene chain;
each p and q is independently 1-15;
each X¹ is independently hydrogen or a monovalent cation;
alternatively, if at least two X¹ are present, then two of X¹ can be taken together and be a divalent cation;
alternatively, if at least three X¹ are present, then three of X¹ can be taken together and be a trivalent cation.

In another embodiment:
n is 0, 1, 2, or 3,
R³ is C₁-C₃₀;
each A¹, A², and A³ is independently C₁-C₈;
p and q is independently 1, 2, or 3;
each X¹ is independently an alkali metal ion, ammonium ion, alkylammonium ion, ammonium ion derivative, imidazolium ion or imidazolium ion derivative;
alternatively, if at least two X¹ are present, then two of X¹ can be taken together and be an alkaline earth metal ion.

In yet another embodiment:
each A¹, A², and A³ is independently —CH₂—, —CH₂CH₂— or —CH₂CH₂CH₂—;
each p and q is independently 1;
each X¹ is independently Na⁺ or K⁺;
alternatively, if at least two X¹ are present, then two of X¹ can be taken together and be Ca⁺² or Mg⁺².

The weak nitrogen amphoteric may be of formula:

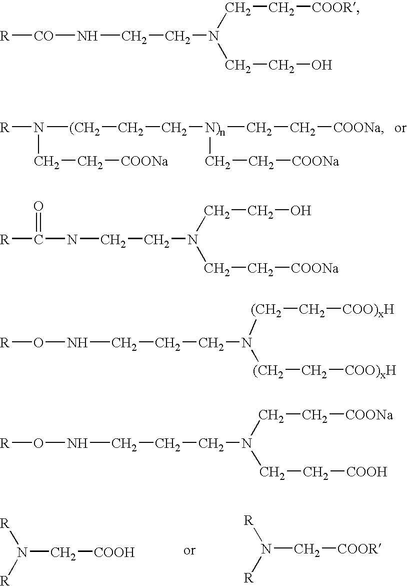

where each R is independently alkyl, e.g., C₈₋₂₄ alkyl; R′ is independently alkyl; and n is, e.g., 1-10; and x is, e.g., 1-10.

A method of treating a material, e.g. a substrate, such as a wood substrate, is provided comprising applying the preservative compositions disclosed herein to the material, or combining the preservative composition with the material, wherein the material is, e.g., a personal care product, household product, industrial product or material, and may be e.g., wood. In one embodiment, the material may be any cellulosic material. The method may comprise applying an effective amount of the composition to inhibit the growth of an organism that effects the material, wherein the organism is, e.g., a fungi or bacteria. In one embodiment, an effective amount of the composition is applied to a wood or cellulosic material to improve stain resistance of the material. Also provided are materials, such as wood or cellulosic materials, treated with the preservative formulations.

### BRIEF DESCRIPTION OF THE FIGURES

FIG. 1 is a graph of IPBC concentration (wt %) vs. time (days) for a study of IPBC stability at 42° C. for varying formulations.

### DETAILED DESCRIPTION OF THE INVENTION

Provided are preservative compositions, which in one embodiment is used in personal care products such as shampoos, conditioners, hair care products, creams, lotions, cosmetics, soap, skin care products; or household products such as laundry detergents, hard surface cleaners, and fabric softeners. In an alternative embodiment, the preservative composition is used in industrial products and materials, such as adhesives, sizes, paper and cardboard, textiles, leather, wood, paints and articles made of plastic, cooling lubricants. In addition, in many industrial applications, the preservative composition can be useful in sealants, rope, paper pump, plastics, fuel, oil, and rubber and metal working fluids and as wood preservatives. Therefore, in one embodiment, the preservative composition can be used for the treatment of materials, including cellulosic materials. In one embodiment, preservative compositions are provided that can be used to provide or help provide stain resistance to wood. The preservative composition can be used in controlling the slime-producing bacteria and fungi in pump and paper mills and cooling towers.

The preservative composition can comprise a combination of an amphoteric compound and a halopropargyl biocide, such as 3-iodo-2-propynyl butyl carbamate (IPBC). The amphoteric compound can be in one embodiment a weak nitrogen amphoteric compound. In another embodiment, the amphoteric compound can be a betaine compound. The composition may include one or more additional additives, such as biocides, including propiconazole or Na-omadine.

Amphoteric compounds useful in the invention are those that include an alkyl group that in one embodiment has a carbon chain length of, e.g., C₆ to C₂₄ (including independently any carbon chain within these), or C₈-C₁₈, or C₁₀ to C₁₈, or, in another embodiment, C₁₂ to C₁₆.

One skilled in the art would recognize that some molecules such as polymers are often synthesized with a molecular weight distribution. For a particular material, it is possible to have either a narrow range (narrow cut) or broader range (broad cut). For example, a particular material could comprise 80% C₁₂ and 20% C₁₄.

The amphoteric compound also includes a nitrogen atom that is positively charged, or can become positively charged in solution. Without being limited to any theory, it is possible that these features of the amphoteric compound have a stabilizing effect on IPBC.

The formulations include amphoteric surfactants that can provide stability or enhanced stability of IPBC in both concentrate and dilute solution. It has also been found that this stability can translate into improved efficacy when used to control the colonization of wood and cellulose by fungi. In particular, the compositions can include a combination of a betaine compound and 3-iodo-2-propynyl butyl carbamate which has stability or enhanced stability.

The formulations in one embodiment are physically stable aqueous formulations. The compositions including an amphoteric compound and IPBC can include further additives such as propiconazole and Na-omadine. The formulations are in one embodiment, a homogenous mixture, optionally with no chemical degradation of the IPBC molecule, and/or with no separation or re-crystallization of components, and/or no gelling. Water soluble or stable micro-emulsions can be prepared as concentrated or diluted, ready-to-work, solutions, that optionally provide no unwanted separation, crystallization, or precipitation. Dilute or concentrated formulations are provided with high stability of active components and a long shelf-life. The formulations permit optimized dispersion of compounds on surfaces such as wood;

In general, when a carbon range is given herein, it is intended to independently include each compound that falls within the referenced class, as if each were separately named.

Halopropargyl Compounds

One class of biocides are those containing a halopropynyl compounds include compounds derived from halopropargyl, such as iodopropargyl alcohols such as the esters, ethers, acetals, carbamates and carbonates and the iodopropargyl derivatives of pyrimidines, triazolinones, tetrazoles, triazinones, sulfamides, benzothiazoles, ammonium salts, carboxamides, hydroxamates, ureas and mixtures thereof. See U.S. Pat. Nos. 3,660,499, 3,923,870, 4,259,350, 4,592,773, 4,616,004, 4,661,632, 4,639,541, 4,647,572, 4,719,227 and 4,945,109, the disclosures of which are herein incorporated by reference. Included within this class of compounds are the halopropargyl carbamates which are known primarily for their fungicidal activity. Preferred among these compounds is 3-iodo-2-propynylbutyl carbamate (IPBC). See Great Britain Patent 2,138,292 and U.S. Pat. Nos. 4,915,909 and 5,082,722.

This compound is included within the broadly useful class of compounds having the generic formula (X): 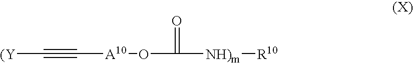
wherein
R¹⁰ is selected from the group consisting of hydrogen, substituted and unsubstituted alkyl groups having from 1 to 20 carbon atoms, aryl, alkylaryl, and aralkyl groups having from 5 to 20 carbon atoms, and substituted and unsubstituted cycloalkyl and cycloalkenyl groups of 3 to 10 carbon atoms;
each A¹⁰ is independently a divalent straight or branched alkylene chain, e.g. C₁-C₈, or —CH₂—, —CH₂CH₂— or —CH₂CH₂CH₂—;
each Y is independently a halogen-fluorine, chlorine, bromine, or iodine;
and m is an independent integer from 1 to 3.

Suitable R¹⁰ substituents include alkyls such as methyl, ethyl, propyl, n-butyl, t-butyl, pentyl, hexyl, heptyl, octyl, nonyl, decyl, dodecyl, octadecyl, cycloalkyls such as cyclopropargyl, cyclohexyl, aryls, alkaryls and aralkyls such as phenyl, benzyl, tolyl, cumyl, halogenated alkyls and aryls, such as chlorobutyl and chlorophenyl, and alkoxy aryls such as ethoxyphenyl and the like.

Preferred are such iodopropargyl carbamates as 3-iodo-2-propynyl propyl carbamate, 3-iodo-2-propynyl butyl carbamate, 3-iodo-2-propynyl hexyl carbamate, 3-iodo-2-propynyl cyclohexyl carbamate, 3-iodo-2-propynyl phenyl carbamate, 3-iodo-2-propynylbenzyl carbamate, 4-iodo-3-butynyl propyl carbamate, and mixtures thereof.

Amphoteric Compounds

As used herein and in the art, the term “amphoteric compound” refers to a compound having both acidic and basic properties.

A variety of amphoteric compounds known in the art may be utilized. Amphoteric compounds having both acidic and basic properties known in the art can be used, such as those described in McCutcheon's, Detergents and Emulsifiers, North American edition (1986), Allured Publishing Corporation; and McCutcheon's, Functional Materials, North American Edition (1992). Nonlimiting examples of amphoteric surfactants include betaines, sultaines, hydroxysultaines, alkyliminoacetates, iminodialkanoates, aminoalkanoates, and mixtures thereof. See e.g., U.S. Pat. No. 6,495,151. Amphoteric resins also can be used. Non-limiting examples include DOWEX Retardion 11A8 50-100 mesh amphoteric resin with a Styrene-DVB acrylic acid macroporous matrix.

Examples of other useful amphoteric surfactants are alkyliminoacetates, and iminodialkanoates and aminoalkanoates of the formulas RN[(CH₂)ₘCO₂M]₂ and RNH(CH₂)ₘCO₂M, wherein m is from 1 to 4, R is a C₈-C₂₂ alkyl or alkenyl, and M is H, alkali metal, alkaline earth metal, ammonium, or alkanolammonium. Also included are imidazolinium and ammonium derivatives. Other examples of suitable amphoteric surfactants include sodium 3-dodecyl-aminopropionate, sodium 3-dodecylamino-propane sulfonate, N-higher alkyl aspartic acids such as those described in U.S. Pat. No. 2,438,091, which is incorporated herein by reference in its entirety; and the products sold under the trade name “Miranol” and described in U.S. Pat. No. 2,528,378, which is incorporated herein by reference in its entirety. Other examples of useful amphoterics include amphoteric phosphates, such as coamidopropyl PG-dimonium chloride phosphate (commercially available as Monaquat PTC, from Mona Corp.). Also useful are amphoacetates such as disodium lauroamphodiacetate, sodium lauroamphoacetate, and mixtures thereof. See, e.g., U.S. Pat. No. 6,491,928, the disclosure of which is incorporated herein by reference.

Other examples of useful amphoterics include amphoteric surfactants as described in EP 0214868 or U.S. Pat. No. 4,769,169, the disclosures of which are incorporated herein.

Weak Nitrogen Amphoterics

Particularly useful amphoterics include weak nitrogen amphoterics such as alkyl amino propionates, alkyl imino dipropionates and imidazoline derivatives. Also useful are alkyl polyamino amphoterics. Weak nitrogen amphoterics do not contain a permanent quaternary nitrogen, but become cationic at low pH. This group contains the real amphoterics that form cations in acidic solutions, anions in alkaline solutions, and ‘zwitterions’ in mid-pH range solutions. The mid-pH range (isoelectric range) in which the surfactant has a neutral charge is compound specific and depends on the alkalinity of the nitrogen atom and the acidity of the carboxylic group (Domsch, A. “Biodegradability of amphoteric surfactants”, Biodegradability of surfactants, In D. R. Karsa and M. R. Porter (eds.), Blackie Academic & Professional, Glasgow, United Kingdom, 1995, p. 231-254).

In one embodiment, the weak nitrogen amphoteric is a fatty amino or imino acid. In another embodiment, the weak nitrogen amphoteric is an imidazoline amphoteric. The term “imidazoline amphoteric” is used in the art to describe amphoteric compounds that comprise or are derived from a compound comprising an imidazoline ring. Amphoteric imidizoline derivatives are often derived from coco fatty acid, caprylic (C₈) and oleic acid and are often based on 1-hydroxy 2-alkyl imidazolines.

The weak nitrogen amphoterics include structures designated as alkylamphoacetates, alkylamphopropionates, and alkyliminopropionates. Particular examples include cocoamphodiacetate, cocoamphoacetate, cocoamphopropionate, cocoamphodipropionate, C₁₂₋₁₈ alkylamphopropionate, C₁₂ alkyliminodipropionate.

Further examples of weak nitrogen amphoteric compounds include cocoamphopolycarboxyglycinate; tallowamphopolcarboxyglycinate; cocoiminoglycinate; cocoamphocarboxyglycinate; oleylamphopolycarboxyglycinate; oleylamphopolycarboxyglycinate; oleylamphopoly-carboxyglycinate; cocoiminopropionate; and octyliminodipropionate.

Weak nitrogen amphoterics can be produced by the reaction of fatty acids or their esters with amines (e.g. aminoethylethanol amine). Alkylamphopropionates may be obtained by the addition of acrylic acid, methyl acrylate, or ethyl acrylate to the reaction product of fatty acids and amines.

In a particular embodiment, the weak nitrogen amphoteric is a commercially available amphoteric compound such as the following. (Amphoterge® products are available from Lonza, N.J., USA).

| PRODUCT | INCI Designation | Chemical Description |
|---|---|---|
| AMPHOTERGE W | Sodium Cocoamphoacetate | Coco imidazoline |
| | | monocarboxylate |
| AMPHOTERGE | Disodium Cocoamphodiacetate | Coco imidazoline dicarboxylate |
| W-2 | | |
| AMPHOTERGE K | Sodium Cocoamphopropionate | Coco imidazoline |
| | | monocarboxylate |
| AMPHOTERGE | Disodium Cocoamphodipropionate | Coco imidazoline dicarboxylate |
| K-2 | | |
| AMPHOTERGE | Disodium | Capric imidazoline dicarboxylate |
| KJ-2 | Capryloamphodipropionate | |
| AMPHOTERGE | Disodium | Capric imidazoline dicarboxylate |
| KJ-2 50% | Capryloamphodipropionate | |
| AMPHOTERGE | Sodium Mixed C₈ | Capric/caprylic carboxylate |
| LF | Amphocarboxylate | |
| AMPHOTERGE | Sodium | cocoamphohydroxyproplysulfonate |
| SB | Cocoamphohydroxypropylsulfonate | |

Other examples of commercially available amphoteric compounds include:

| Product | Description |
|---|---|
| Miranol JEM conc. | Sodium Alkyl amphocarboxylate |
| (Rhodia) | |
| Mirataine JC-HA | aminopropionate |
| (Rhodia) | |
| Lakeland AMA 38, | Propionates (mono, di) |
| and LF60 | |
| (Lakeland | |
| Laboratory Limited) | |
| Ampholak YCE, | Octo- or Coco-imidopropionate |
| YJH-40 | |
| (Akzo Noble) | |
| Ampholak 7TX | Tallowampho-polycarboxyglycinate |
| (Akzo Noble) | |
| Ampholak XCE | Coco-iminoglycinate |
| (Akzo Noble) | |
| Ampholak XCO-30 | Cocoampho carboxyglycinate |
| (Akzo Noble) | |
| imidopropionates | Amphoteric IL, LH, TC, or 400 |
| (Tomah³ Product, | |
| Inc.) | |

In yet another embodiment, the weak nitrogen amphoteric is a compound of the Formula (I): 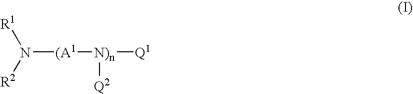
wherein
each n is independently 0-15, e.g., n is 0, 1, 2, or 3;
each R¹ and R² is independently H, alkyl, —R³, acyl, —COR³, alkoxy, —OR³ or -Q³; wherein at most one of R¹ and R² is H and at most one of R¹ and R² is acyl, —COR³, alkoxy, or —OR³;
each R³ is independently a straight or branched alkyl chain, e.g., C₁-C₃₀;
each Q¹, Q², and Q³ is independently hydrogen, -(A²-COO)ₚX¹ or -(A³-O)_{q}H;

wherein at least one Q¹, Q² or Q³ is independently -(A²-COO)ₚX¹;
each A¹, A², and A³ is independently a divalent straight or branched alkylene chain, e.g., C₁-C₈, or —CH₂—, —CH₂CH₂— or —CH₂CH₂CH₂—;
each p and q is independently 1-15, e.g., each p and q is independently 1, 2, or 3, or, e.g., each p and q is independently 1;
each X¹ is independently hydrogen or a monovalent cation, e.g., an alkali metal ion (such as Na⁺ or K⁺), ammonium ion, alkylammonium ion, ammonium ion derivative, imidazolium ion or imidazolium ion derivative;
alternatively, if at least two X¹ are present, then two of X¹ can be taken together and be a divalent cation, e.g., an alkaline earth metal ion, such as Ca⁺² or Mg⁺²;
alternatively, if at least three X¹ are present, then three of X¹ can be taken together and be a trivalent cation.

In one embodiment, one of R¹ and R² is -(A⁴-COO)ₚX¹. In another embodiment, both of R¹ and R² are independently -(A⁴-COO)ₚX¹. In another embodiment, neither R¹ nor R² is -(A⁴-COO)ₚX¹.

In a first sub-embodiment, the weak nitrogen amphoteric is a compound of the Formula (I-A): 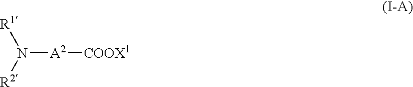
wherein R³, A¹ and X¹ are as defined above; and
R^{1′} and R^{2′} is independently H, alkyl, or —R³; wherein at most one of R^{1′} and R^{2′} is H.

In a particular sub-embodiment, the weak nitrogen amphoteric is a compound of the Formula (I-A-1). 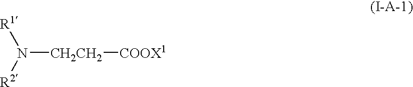
wherein R³ and X¹ are as defined above; and
R^{1′} and R^{2′} is independently H, alkyl, or —R³; wherein at most one of R^{1′} and R^{2′} is H.
In an even more particular sub-embodiment, the weak nitrogen amphoteric is sodium N-coco amino propionate.

In a second sub-embodiment, the weak nitrogen amphoteric is a compound of the Formula (I-B): 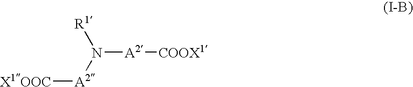
wherein R³ is as defined above;
R^{1′} is independently H, alkyl, or —R³;
each A^{2′} and A^{2′} is independently a divalent straight or branched alkylene chain, e.g. C₁-C₈, or e.g., —CH₂CH₂—;
each X^{1′} and X^{1″} is independently hydrogen or a monovalent cation, e.g., an alkali metal ion (such as Na⁺ or K⁺), ammonium ion, alkylammonium ion, ammonium ion derivative, imidazolium ion or imidazolium ion derivative;
alternatively, X^{1′} and X^{1″} can be taken together and be a divalent cation, e.g., an alkaline earth metal ion, such as Ca⁺² or Mg⁺².

In a particular sub-embodiment, the weak nitrogen amphoteric is a compound of the Formula (I-B-1): 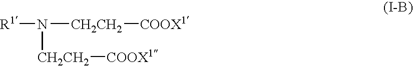
wherein R³ is as defined above;
R^{1′} is independently H, alkyl, or —R³;
each X^{1′} and X^{1″} is independently hydrogen or a monovalent cation, e.g., an alkali metal ion (such as Na⁺ or K⁺), ammonium ion, alkylammonium ion, ammonium ion derivative, imidazolium ion or imidazolium ion derivative; alternatively, X^{1′} and X^{1″} can be taken together and be a divalent cation, e.g., an alkaline earth metal ion, such as Ca⁺² or Mg⁺².

In an even more particular sub-embodiment, the weak nitrogen amphoteric is disodium N-tallow imino dipropionate. Alternatively, the weak nitrogen amphoteric is disodium N-lauryl imino dipropionate.

In a third sub-embodiment, the weak nitrogen amphoteric is a compound of the Formula (I-C): 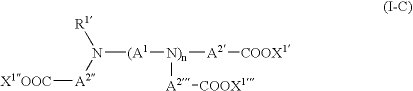
wherein n and A¹ are as defined above;
R^{1′} is independently H, alkyl, or —R³;
each A^{2′}, A^{2″}, and A^{2′″} is independently a divalent straight or branched alkylene chain, e.g., C₁-C₈, or, e.g., —CH₂CH₂—;
each X^{1′}, X^{1″}, and X^{1′″} is independently hydrogen or a monovalent cation, e.g., an alkali metal ion (such as Na⁺ or K⁺), ammonium ion, alkylammonium ion, ammonium ion derivative, imidazolium ion or imidazolium ion derivative;
alternatively, two of X^{1′}, X^{1″}, and X^{1′″} can be taken together and be a divalent cation, e.g. an alkaline earth metal ion, such as Ca⁺² or Mg⁺²; alternatively, three of X^{1′}, X^{1″}, and X^{1′″} can be taken together and be a trivalent cation.

In a particular sub-embodiment, the weak nitrogen amphoteric is a compound of the Formula (I-C-1): 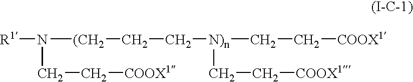
wherein n is as defined above;
R^{1′} is independently H, alkyl, or —R³;
each X^{1′}, X^{1″}, and X^{1′″} is independently hydrogen or a monovalent cation, e.g., an alkali metal ion (such as Na⁺ or K⁺), ammonium ion, alkylammonium ion, ammonium ion derivative, imidazolium ion or imidazolium ion derivative;
alternatively, two of X^{1′}, X^{1″}, and X^{1′″} can be taken together and be a divalent cation, e.g., an alkaline earth metal ion, such as Ca⁺² or Mg⁺²;
alternatively, three of X^{1′}, X^{1″}, and X^{1′″} can be taken together and be a trivalent cation.

In another particular sub-embodiment, the weak nitrogen amphoteric is a compound of the Formula (I-C-2): 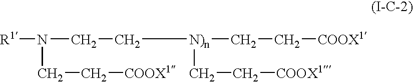
wherein n is as defined above;
R^{1′} is independently H, alkyl, or —R³;
each X^{1′}, X^{1″}, and X^{1′″} is independently hydrogen or a monovalent cation, e.g., an alkali metal ion (such as Na⁺ or K⁺), ammonium ion, alkylammonium ion, ammonium ion derivative, imidazolium ion or imidazolium ion derivative;
alternatively, two of X^{1′}, X^{1″}, and X^{1′″} can be taken together and be a divalent cation, e.g., an alkaline earth metal ion, such as Ca⁺² or Mg⁺²;
alternatively, three of X^{1′}, X^{1″}, and X^{1′″} can be taken together and be a trivalent cation.

In a fourth sub-embodiment, the weak nitrogen amphoteric is a compound of the Formula (I-D): 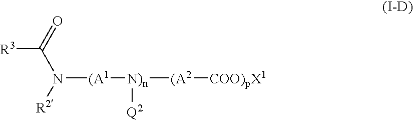
wherein n, p, R³, Q². A¹, A² and X¹ are as defined above; and
R² is independently H, alkyl, or —R³.

In a particular sub-embodiment, the weak nitrogen amphoteric is a compound of the Formula (I-D-1): 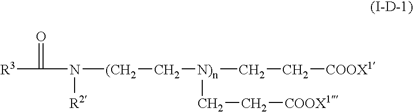
wherein n and R³ are as defined above;
R^{2′} is independently H, alkyl, or —R³;
each X^{1′} and X^{1′″} is independently hydrogen or a monovalent cation, e.g., an alkali metal ion (such as Na⁺ or K⁺), ammonium ion, alkylammonium ion, ammonium ion derivative, imidazolium ion or imidazolium ion derivative.
alternatively, two of X^{1′} and X^{1′″} can be taken together and be a divalent cation, e.g., an alkaline earth metal ion, such as Ca⁺² or Mg⁺²;

In another particular sub-embodiment, the weak nitrogen amphoteric is a compound of the Formula (I-D-2): 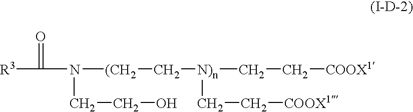
wherein n and R³ are as defined above;
each X^{1′} and X^{1′″} is independently hydrogen or a monovalent cation, e.g., an alkali metal ion (such as Na⁺ or K⁺), ammonium ion, alkylammonium ion, ammonium ion derivative, imidazolium ion or imidazolium ion derivative;
alternatively, two of X^{1′} and X^{1′″} can be taken together and be a divalent cation, e.g., an alkaline earth metal ion, such as Ca⁺² or Mg⁺².

In yet another particular sub-embodiment, the weak nitrogen amphoteric is a compound of the Formula (I-D-3): 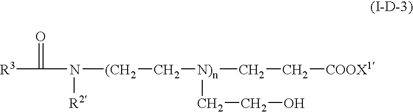
wherein n and R³ are as defined above;
R^{2′} is independently H, alkyl, or —R³;
each X^{1′} is independently hydrogen or a monovalent cation, e.g., an alkali metal ion (such as Na⁺ or K⁺), ammonium ion, alkylammonium ion, ammonium ion derivative, imidazolium ion or imidazolium ion derivative.

In yet another particular sub-embodiment, the weak nitrogen amphoteric is a compound of the Formula (I-D4): 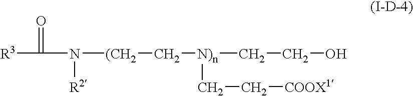
wherein n and R³ are as defined above;
R^{2′} is independently H, alkyl, or —R³;
each X^{1′} is independently hydrogen or a monovalent cation, e.g., an alkali metal ion (such as Na⁺ or K⁺), ammonium ion, alkylammonium ion, ammonium ion derivative, imidazolium ion or imidazolium ion derivative;
alternatively, two of X^{1′} can be taken together and be a divalent cation, e.g., an alkaline earth metal ion, such as Ca⁺² or Mg⁺².

In an even more particular sub-embodiment, the weak nitrogen amphoteric is a compound of the Formula (I-D-4a): 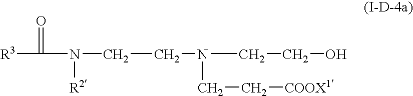
wherein R³ is as defined above;
R^{2′} is independently H, alkyl, or —R³;
each X^{1′} and X^{1′″} is independently hydrogen or a monovalent cation, e.g., an alkali metal ion (such as Na⁺ or K⁺), ammonium ion, alkylammonium ion, ammonium ion derivative, imidazolium ion or imidazolium ion derivative;
alternatively, two of X^{1′} and X^{1′″} can be taken together and be a divalent cation, e.g., an alkaline earth metal ion, such as Ca⁺² or Mg⁺².

In a fifth sub-embodiment, the weak nitrogen amphoteric is a compound of the Formula (I-E): 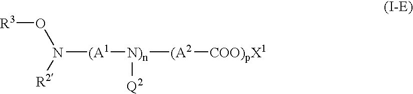
wherein n, p, R³, Q², A¹, A² and X¹ are as defined above; and
R^{2′} is independently H, alkyl, or —R³.

In a particular sub-embodiment, the weak nitrogen amphoteric is a compound of the Formula (I-E-1): 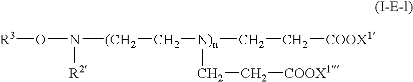
wherein n and R³ are as defined above;
R^{2′} is independently H, alkyl, or —R³;
each X^{1′} and X^{1′″} is independently hydrogen or a monovalent cation, e.g., an alkali metal ion (such as Na⁺ or K⁺), ammonium ion, alkylammonium ion, ammonium ion derivative, imidazolium ion or imidazolium ion derivative.
alternatively, two of X^{1′} and X^{1′″} can be taken together and be a divalent cation, e.g., an alkaline earth metal ion, such as Ca⁺² or Mg⁺²;

In another particular sub-embodiment, the weak nitrogen amphoteric is a compound of the Formula (I-E-2): 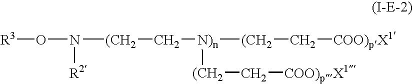
wherein n and R³ are as defined above;
R^{2′} is independently H, alkyl, or —R³;
each p′ and p′″ is independently 1-15, e.g., each p and q is independently 1, 2, or 3, e.g., each p and q is independently 1;
each X^{1′} and X^{1′″} is independently hydrogen or a monovalent cation, e.g., an alkali metal ion (such as Na⁺ or K⁺), ammonium ion, alkylammonium ion, ammonium ion derivative, imidazolium ion or imidazolium ion derivative;
alternatively, two of X^{1′} and X^{1′″} can be taken together and be a divalent cation, e.g., an alkaline earth metal ion, such as Ca⁺² or Mg⁺².

In an even more particular sub-embodiment, the weak nitrogen amphoteric is a compound of the Formula (I-E-2a): 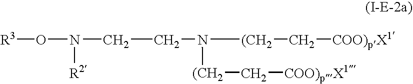
wherein R³ is as defined above;
R^{2′} is independently H, alkyl, or —R³;
each p′ and p′″ is independently 1-15, e.g., each p and q is independently 1, 2, or 3, e.g., each p and q is independently 1;
each X^{1′} and X^{1′″} is independently hydrogen or a monovalent cation, e.g., an alkali metal ion (such as Na⁺ or K⁺), ammonium ion, alkylammonium ion, ammonium ion derivative, imidazolium ion or imidazolium ion derivative;
alternatively, two of X^{1′} and X^{1′″} can be taken together and be a divalent cation, e.g., an alkaline earth metal ion, such as Ca⁺² or Mg⁺².

In yet another particular sub-embodiment, the weak nitrogen amphoteric is a compound of the Formula (I-E-3): 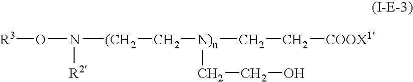
wherein n and R³ is as defined above;
R^{2′} is independently H, alkyl, or —R³;
each X^{1′} is independently hydrogen or a monovalent cation, e.g., an alkali metal ion (such as Na⁺ or K⁺), ammonium ion, alkylammonium ion, ammonium ion derivative, imidazolium ion or imidazolium ion derivative.

In yet another particular sub-embodiment, the weak nitrogen amphoteric is a compound of the Formula (I-E4): 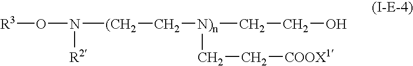
wherein n and R³ is as defined above;
R^{2′} is independently H, alkyl, or —R³;
each X^{1′} is independently hydrogen or a monovalent cation, e.g., an alkali metal ion (such as Na⁺ or K⁺), ammonium ion, alkylammonium ion, ammonium ion derivative, imidazolium ion or imidazolium ion derivative;
alternatively, two of X^{1′} can be taken together and be a divalent cation, e.g., an alkaline earth metal ion, such as Ca⁺² or Mg⁺².

In an even more particular sub-embodiment, the weak nitrogen amphoteric is a compound of the Formula (I-E4a): 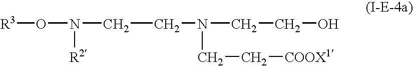
wherein R³ is as defined above;
R^{2′} is independently H, alkyl, or —R³;
each X^{1′} and X^{1′″} is independently hydrogen or a monovalent cation, e.g., an alkali metal ion (such as Na⁺ or K⁺), ammonium ion, alkylammonium ion, ammonium ion derivative, imidazolium ion or imidazolium ion derivative;
alternatively, two of X^{1′} and X^{1′″} can be taken together and be a divalent cation, e.g., an alkaline earth metal ion, such as Ca⁺² or Mg⁺².

Exemplary weak nitrogen amphoterics are shown below.

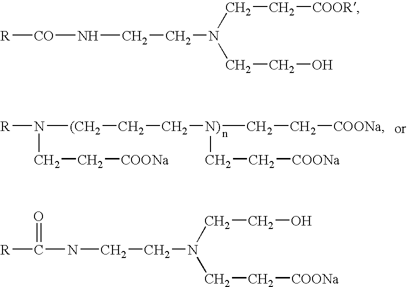

where R is independently alkyl, e.g., C₈₋₂₄ alkyl; R¹ is alkyl; and n is e.g, 1-10, e.g., 1 or 5.

Exemplary ethoxylated amines are shown below.

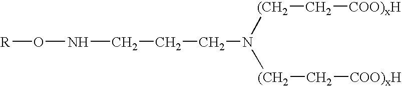

wherein R is alyl, e.g., C₆₋₂₄, or C₈₋₂₄ or C₁₀-C₁₅; and x is, e.g., 1-10, e.g., 1 or 5.

Exemplary ether-alcohol amphoterics are shown below.

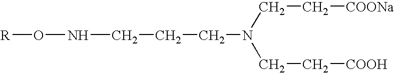

wherein R is alkyl, e.g., C₆₋₂₄ or C₈₋₂₄.

Other useful formulations are formulations including an amino acid or amino acid ester based surfactant optionally in combination with IPBC and/or other actives, as shown below: 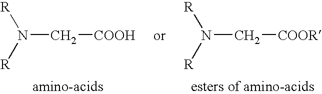
where R is independently alkyl, e.g., C₆-C₂₄, C₈₋₁₈, C₁₀₋₁₈, C₁₂₋₁₆ or C₈₋₂₄.

Betaine Compounds

As used herein, “betaine” or “betaine compound”, unless otherwise specified, includes the compound, 2-(trimethylammonio)ethanoic acid (or trimethylammonio-acetate), as well as other compounds known in the art as betaines which are chemical compounds that resemble trimethylammonioacetate, and are slightly basic amphoteric zwitterionic bases typically characterized by a COO⁻ moiety or SO₃⁻ moiety and a permanent quaternary nitrogen group. These molecules have been referred to as “betaines” and are described and known in the art.

Betaine compounds are typically overall neutral molecules, not characterized by a dissociation constant specific to an ionic molecule in aqueous system. Betaines include carboxybetaines (with a COO⁻ group) and sulphobetaines (with a SO₃⁻ group), and can be in one embodiment based on either tertiary fatty amines or bridged tertiary amines containing an amidopropyl group.

The betaine compound in one embodiment comprises an alkyl group, that is e.g. C₁₋₂₄ alkyl. For example, the alkyl group may be a straight chain C₈ to C₂₄ alkyl; a straight chain C₈₋₁₈ or C₁₀ to C₁₈ alkyl; or, optionally a C₁₂ to C₁₆ straight chain alkyl.

The most commonly used alkylamido betaine is alkylamidopropyl betaine (e.g., cocoamidopropyl betaine), whereas alkylamidoethyl betaines are used in smaller amounts. Further examples include C₁₂-14 alkyl betaine; C₁₂-18 alkyl betaine; cocoalkyl betaine; cocoalkyl amidopropyl betaine; C₁₄₋₁₅ hydroxysulfo betaine; cocoalkyl hydroxysulfo betaine; and cocoamidopropyl betaine.

As used herein, the term alkyl, unless otherwise specified, includes a saturated straight, branched, or cyclic, primary, secondary or tertiary hydrocarbon of for example C₁ to C₃₀, and specifically includes methyl, ethyl, propyl, isopropyl, cyclopropyl, butyl, isobutyl, t-butyl, pentyl, isopentyl, cyclopentyl, isopentyl, neopentyl, hexyl, isohexyl, cyclohexyl, cyclohexylmethyl, 3-methylpentyl, 2,2-dimethylbutyl, and 2,3-dimethylbutyl. In one embodiment, the alkyl may be substituted, e.g., with a substituent such as halogen (fluoro, chloro, bromo or iodo), hydroxyl, amino, alkylamino, arylamino, alkoxy, aryloxy, nitro, cyano, sulfonic acid, sulfate, phosphonic acid, phosphate, or phosphonate, either unprotected, or protected as necessary, as known to those skilled in the art, for example, as taught in Greene, et al., Protective Groups in Organic Synthesis, John Wiley and Sons, Second Edition, 1991, hereby incorporated by reference.

A range of possible carbon lengths recited herein includes independently any carbon chain length within the range.

In one embodiment, the betaine is a carboxybetaine. In another embodiment, the betaine is a sulphobetaine.

In another embodiment, the betaine is a compound of the Formula (II): 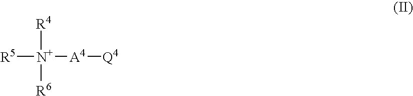
wherein
each R⁴, R⁵, and R⁶ is independently alkyl, —R⁷, alkoxy, -A⁵-OH, -(A⁵-O)ᵣH, fatty amido alkyl group, such as a fatty amido propyl group, -A⁵-N—C(═O)OH, or -A⁵-N—C(O)R⁷;
each R⁷ is independently a straight or branched alkyl chain, e.g., C₁-C₃₀;
each Q⁴ is independently —CO₂⁻ or —SO₃⁻;
each A⁴ and A⁵ is independently a divalent straight or branched alkylene chain, e.g., C₁-C₈, and even more e.g., —CH₂—, —CH₂CH₂—, or —CH₂CH₂CH₂—;
each r is independently 1-15, e.g., each r is independently 1, 2, or 3, and in another embodiment each r is independently 1.

In some embodiments, A⁴ and/or A⁵ may optionally be substituted with one or more hydroxyl group(s).

In a first embodiment, the betaine is a compound of the Formula (II-A): 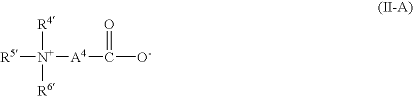
wherein R⁷ and A⁴ are as defined above;
each R^{4′}, R^{5′}, and R^{6′} is independently alkyl or —R⁷.

In another embodiment the betaine is a compound of the Formula (II-A-1): 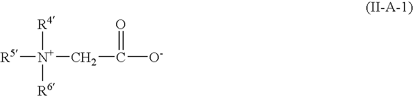
wherein R^{5′} is a hydrocarbon chain, for example, a straight chain C₂₋₂₄, C₈₋₂₄, C₁₀₋₁₈ or C₁₂₋₁₆ group; and
R^{4′} and R^{6′} are the same or different, and are methyl, or C₃ alkyl.

In another embodiment, the betaine is a compound of the Formula (II-A-1a): 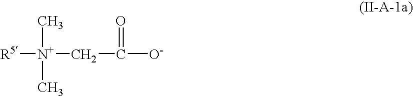
wherein R^{5′} is a hydrocarbon chain, for example, a straight chain C₂₋₂₄, C₈₋₂₄, C₁₀₋₁₈ or C₁₂₋₁₆ group.

In a second embodiment, the betaine is a compound of the Formula (II-B): 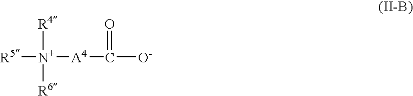
wherein R⁷ and A⁴ are as defined above;
each R^{4″}, R^{5″}, and R^{6″} is independently alkyl, —R⁷, alkoxy, -A⁵-OH, or -(A⁵-O)ᵣH;

wherein in at least one of R^{4″}, R^{5″}, and R^{6″} is alkoxy, -A⁵-OH or -(A⁵-O)ᵣH.

In one embodiment, two of R^{4″}, R^{5″}, and R^{6″} are alkoxy, -A⁵-OH or -(A⁵-O)ᵣH.

In one embodiment, the betaine is a compound of the Formula (II-B-1): 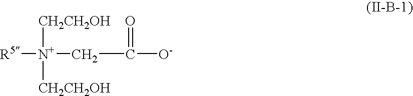
wherein R^{5″} is independently alkyl, or —R⁷, and R⁷ is as defined above.

In a third embodiment, the betaine is a compound of the Formula (II-C): 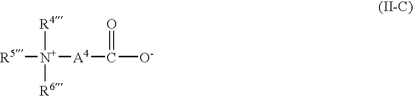
wherein R⁷, A⁴, and A⁵ are as defined above;
each R^{4′″}, R^{5′″}, and R^{6′″} is independently alkyl, fatty amido alkyl group, such as a fatty amido propyl group, -A⁵-N—C(═O)OH, or -A⁵-N—C(═O)R⁷; wherein in at least one of R^{4′″}, R^{5′″}, and R^{6′″} is fatty amido alkyl group, such as a fatty amido propyl group, -A⁵-N—C(═O)OH, or -A⁵-N—C(═O)R⁷.

In another embodiment, the betaine is a compound of the Formula (II-C-1): 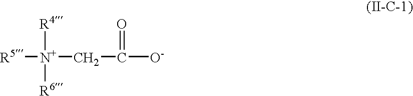
wherein A⁵ and R⁷ are as defined above;
R^{5′″} is a fatty amido alkyl group, such as a fatty amido propyl group, -A⁵-N—C(═O)OH, or -A⁵-N—C(═O)R⁷; and
R^{4′″} and R^{6′″} are the same or different, and are methyl, or C₃ alkyl.

In another embodiment, the betaine is a compound of the Formula (II-C-1a): 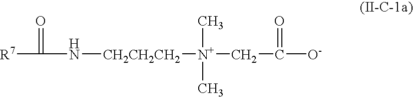
wherein R⁷ is as defined above, e.g., C₂₋₂₄; C₈₋₂₄; C₉₋₁₃; C₁₀₋₁₈ or C₁₂₋₁₆ alkyl, such as straight chain alkyl.

Such compounds are also referred to as cocamidopropylbetaines.

In some embodiments, the alkyl chain is a hydrocarbon chain of about C₈ to C₂₄. One preferred chain length is about C₁₀ to C₁₈, and another preferred chain length is about C₁₂ to C₁₆

In a fourth embodiment, the betaine is a compound of the Formula (II-D): 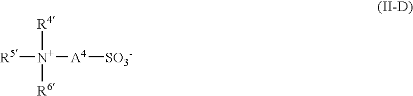
wherein R⁷ and A⁴ are as defined above;
each R^{4′}, R^{5′}, and R^{6′} is independently alkyl or —R⁷.

In a fifth embodiment, the betaine is a compound of the Formula (II-E): 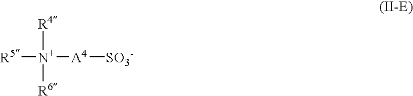
wherein R⁷ and A⁴ are as defined above;
each R^{4″}, R^{5″}, and R^{6″} is independently alkyl, —R⁷, alkoxy, -A⁵-OH, or -(A⁵-O)ᵣH;

wherein in at least one of R^{4″}, R^{5″}, and R^{6″} is alkoxy, -A⁵-OH or -(A⁵-O)ᵣH.

In another embodiment, two of R^{4″}, R^{5″}, and R^{6″} are alkoxy, -A⁵-OH or -(A⁵-O)ᵣH.

In another embodiment, the betaine is a compound of the Formula (II-F): 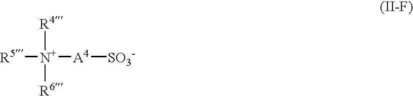
wherein R⁷, A⁴, and A⁵ are as defined above;
each R^{4′″}, R^{5′″}, and R^{6′″} is independently alkyl, fatty amido alkyl group, such as a fatty amido propyl group, -A⁵-N—C(═O)OH, or -A⁵-N—C(═O)R⁷; wherein in at least one of R^{4′″}, R^{5′″}, and R^{6′″} is fatty amido alkyl group, such as a fatty amido propyl group, -A⁵-N—C(═O)OH, or -A⁵-N—C(—O)R⁷.

In another embodiment, the betaine is a compound of the Formula (II-F-1): 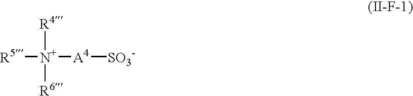
wherein A⁵ and R⁷ are as defined above;
R^{5′″} is a fatty amido alkyl group, such as a fatty amido propyl group, -A⁵-N—C(═O)OH, or -A⁵-N—C(═O)R⁷; and
R^{4′″} and R^{6′″} are the same or different, and are methyl, or C₃ alkyl.

In another embodiment, the betaine is a compound of the Formula (II-F-1a): 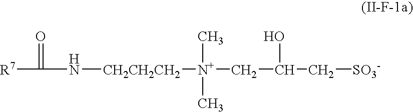
wherein R⁷ is as defined above, e.g. C₂₋₂₄; C₈₋₂₄; C₉₋₁₃; C₁₀₋₁₈ or C₁₂₋₁₆ alkyl, such as straight chain alkyl.

Examples of sultaines and hydroxysultaines include materials such as cocamidopropyl hydroxysultaine (available as Mirataine CBS from Rhone-Poulenc). See e.g., U.S. Pat. Nos. 6,495,151 and 6,491,928.

Exemplary betaines include alkyl bis(hydroxyethyl)betaines, alkyl dimethyl betaines, alkyl amidopropyl dimethyl betaines, coco betaine, tallow bis(hydroxyethyl)betaine, coco amidopropyl betaine, and carboxybetaines.

A variety of betaines known in the art can be used, such as higher alkyl betaines. Exemplary betaines include coco dimethyl carboxymethyl betaine, lauryl dimethyl carboxymethyl betaine, lauryl dimethyl alphacarboxyethyl betaine, cetyl dimethyl carboxymethyl betaine, cetyl dimethyl betaine (available as Lonzaine 16SP from Lonza Corp.), lauryl bis-(2-hydroxyethyl)carboxymethyl betaine, oleyl dimethyl gamma-carboxypropyl betaine, lauryl bis-(2-hydroxypropyl)alpha-carboxyethyl betaine, coco dimethyl sulfopropyl betaine, lauryl dimethyl sulfoethyl betaine, lauryl bis-(2-hydroxyethyl)sulfopropyl betaine, amidobetaines and amidosulfobetaines (wherein the RCONH(CH₂)₃ radical is attached to the nitrogen atom of the betaine), oleyl betaine (available as amphoteric Velvetex OLB-50 from Henkel), and cocamidopropyl betaine (available as Velvetex BK-35 and BA-35 from Henkel). See, e.g., the disclosure of betaines in U.S. Pat. No. 6,495,151, the disclosure of which is incorporated herein by reference.

Other useful compounds include Amphosol CA or CG from Stapan. Amphosol CA has the structure: (C₃H₇)₃N⁺−(C₈H₁₆)—CO—O⁻.

One embodiment of preferred betaines, available commercially from Lonza Group Ltd. (Basel, Switzerland), include cocoamidopropyl betaines, cetyl betaines, and sulfobetaines. Examples include coco amido propyl dimethyl betaine; cetyl betaine((carboxylatomethyl)hexadecyldimethylammonium); and coco amido propyl dimethyl sultaine(cocoamidopropyl-N,N-dimethyl-N-2-hydroxypropyl sulfobetaine).

Useful betaines include Lonzaine 12S, available from Lonza Corp. (also referred to as laurylbetaine; lauryldimethylbetaine; or N-dodecyl-N,N-dimethylbetaine), which is commercially available as a mixture with sodium chloride and ethyl alcohol, and water. In another embodiment, the betaine is Lonzaine 16SP (also referred to as (dimethylhexadecylbetain, N,N-dimethyl-N-hexadecylaminoacetic acid or cetyl betaine), available from Lonza Corp., as a mixture with ethanol, sodium chloride, sodium glycolate and water. The structures are shown below:
(CH₃)₂(C₁₂H₂₅)N⁺−CH₂—CO—O⁻ (Lonzaine 12S)
(CH₃)₂(C₁₆H₃₂)—N⁺−CH₂—CO—O⁻ (Lonzaine 16SP)

In one embodiment, the betaine or sultaine is commercially available, optionally selected from the compounds set forth below:

| PRODUCT | |
|---|---|
| (Supplier) | BETAINE DESCRIPTION |
| Lonzaine C | Coco Amido Propyl Dimethyl Betaine |
| (Lonza Group) | |
| Lonzaine CO | Coco Amido Propyl Dimethyl Betaine |
| (Lonza Group) | |
| Lonzaine CS | Coco Amido Propyl Hydroxy Dimethyl |
| (Lonza Group) | Sultaine |
| Lonzaine 16SP | Cetyl Dimethyl Betaine |
| (Lonza Group) | |
| Lonzaine 12S | Lauryl Dimethyl Betaine |
| (Lonza Group) | |
| Lakeland CTA-N | Amido-betains |
| (Lakeland Laboratory | |
| Limited) | |
| Amphoteen 24 | Lauryldimethyl betain |
| (Akzo Noble) | |
| Amphosol CA, CG, and | Co-amodopropyl betain |
| HCG, HCG-50 | |
| (Stepan) | |
| Amphosol CDB | Cetyl betain |
| (Stepan) | |
| Amphosol LB | Lauramidopropyl betain |
| (Stepan) | |
| Miranate B | Alkylether hydroxypropyl sultaine |
| (Rhodia) | |

### OTHER EMBODIMENTS OF AMPHOTERICS

In one embodiment, the amphoteric compound is of the formula:

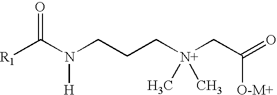

wherein M⁺ is a cation such as H⁺, or such as a metal cation such as Na⁺;

and wherein R¹ is a straight chain C₈ to C₂₀ alkyl or alkenyl, for example, caprylic, lauric, cetyl, palmitic, oleic, or stearic; and the population of molecules may contain a mixed variety of R¹ chain lengths.

In another embodiment the amphoteric compound has the formula:

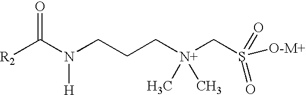

wherein M⁺ is a cation such as H⁺, or such as a metal cation such as Na⁺;

and wherein R₂ is a straight chain C₈ to C₂₀ alkyl or alkenyl, for example, caprylic, lauric, cetyl, palmitic, oleic, or stearic; and the population of molecules may contain a mixed variety of R₂ chain lengths.

In another embodiment the amphoteric compound has the formula:

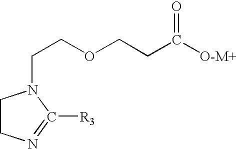

wherein M⁺ is a cation such as H⁺, or a metal cation such as Na⁺;

and wherein R₃ is a straight chain C₈ to C₂₀ alkyl or alkenyl, for example, caprylic, lauric, cetyl, palmitic, oleic, or stearic; and optionally the population of molecules may contain a mixed variety of R₃ chain lengths.

In another embodiment the amphoteric compound has the formula:

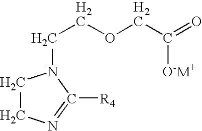

wherein M⁺ is a cation such as H⁺, or a metal cation such as Na⁺;

and wherein R⁴ is a C₇ to C₁₉ straight chain alkyl or alkenyl, for example caprylic, lauric, cetyl, palmitic, oleic, or stearic; and the population of molecules may contain a mixed variety of R⁴ chain lengths.

In another embodiment the amphoteric compound has the formula:

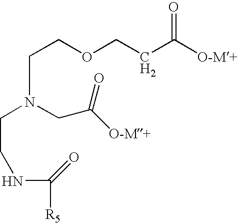

wherein M′⁺ and M″⁺ are independently a cation such as H⁺, or a metal cation such as Na⁺;

and wherein R₅ is a straight chain C₇ to C₁₉ alkyl or alkenyl, for example caprylic, lauric, cetyl, palmitic, oleic, or stearic; and the population of molecules may contain a mixed variety of R₅ chain lengths.

In another embodiment the amphoteric compound has the formula: 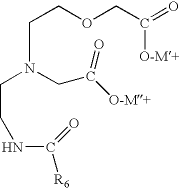
wherein M′⁺ and M″⁺ are independently a cation such as H⁺, or such as a metal cation such as Na⁺;

and wherein R₆ is a straight chain C₇ to C₁₉ alkyl or alkenyl, for example a caprylic, lauric, cetyl, palmitic, oleic, or stearic chain; and the population of molecules may contain a mixed variety of R₆ chain lengths.

In another embodiment the amphoteric compound has the formula:

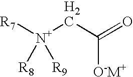

wherein M⁺ is a cation such as H⁺, or such as a metal cation such as Na⁺;

and wherein R₇ is a straight chain C₈ to C₂₀ alkyl or alkenyl, for example, caprylic, lauric, cetyl, palmitic, oleic, or stearic chains, or optionally R₇ may be a fatty amidopropyl group; and the population of molecules may contain a mixed variety of R₇ chain lengths;

and wherein R⁸ and R₉ are independently or each methyl or hydroxyethyl groups.

In another embodiment the amphoteric compound has the formula:

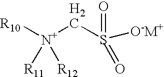

wherein M⁺ is a cation such as H⁺, or such as a metal cation such as Na⁺;

and wherein R₁₀ is a straight chain C₈ to C₂₀ alkyl or alkenyl, for example, caprylic, lauric, cetyl, palmitic, oleic, or stearic chains, an optionally R₁₀ is a fatty amidopropyl group; and wherein the population of molecules may contain a mixed variety of R¹⁰ chain identities;

and wherein R₁₁ and R₁₂ are independently or each methyl or hydroxyethyl groups.

In another embodiment the amphoteric compound has the formula:

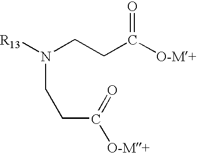

wherein M′⁺ and M″⁺ are independently a cation such as H⁺, or such as a metal cation such as Na⁺;

and wherein R₁₃ is a straight chain C₈ to C₂₀ alkyl or alkenyl, for example, caprylic, lauric, cetyl, palmitic, oleic, or stearic chains, and optionally R₁₃ is a fatty amidopropyl group; and wherein the population of molecules may contain a mixed variety of R₁₃ chains.

In another embodiment the amphoteric compound has the formula:

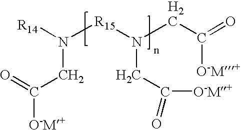

wherein M′⁺ and M″⁺ and M′″⁺ are independently a cation such as H⁺, or such as a metal cation such as Na⁺;

and wherein R₁₄ is a C₈ to C₂₀ alkyl or alkenyl, for example, caprylic, lauric, cetyl, palmitic, oleic, or stearic, and R₁₄ is optionally a fatty amidopropyl group; and wherein the population of molecules may contain a mixed variety of R₁₄ chain identities;

and wherein R₁₅ is 1,2-ethane-diyl or 1,3-propane-diyl;

and wherein n is 0 to 10.

In another embodiment the amphoteric compound has the formula:

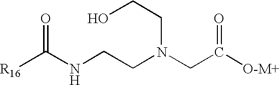

wherein M⁺ is a cation such as H⁺, or such as a metal cation such as Na⁺;

and wherein R₁₆ is a C₈ to C₂₀ alkyl or alkenyl, for example, caprylic, lauric, cetyl, palmitic, oleic, or stearic chains, and the population of molecules may contain a mixed variety of R₁₆ chains;

In another embodiment the amphoteric compound has the formula:

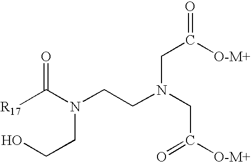

wherein M′⁺ and M″⁺ independently a cation such as H⁺, or such as a metal cation such as Na⁺;

and wherein R₁₆ is a straight chain C₈ to C₂₀ alkyl or alkenyl, for example, caprylic, lauric, cetyl, palmitic, oleic, or stearic chains, and the population of molecules may contain a mixed variety of R₁₆ chains.

In another embodiment, the amphoteric compound, has the formula:
RC(═O)NHCH₂CH₂NCH₂COONa; or
RN(CH₂COONa)CH₂CH₂N(CH₂COONa)CH₂CH₂N(CH₂COONa)₂;

wherein R is alkyl or alkenyl, e.g. C₈-C₂₀ alkyl or alkenyl, for example, caprylic, lauric, cetyl, palmitic, oleic, or stearic, and the population of molecules may contain a mixed variety of R chains.

In one embodiment, the amphoteric compound is Amphoterge® K from Lonza, having the following structure (referred to as coco imidazoline monocarboxylate; cocoamphopropionate; or 3-[2(4,5-dihydro-2-undecyl-1H-imidazol-1-yl)ethoxy]propionic acid sodium salt; CAS no. 61901-02-8).

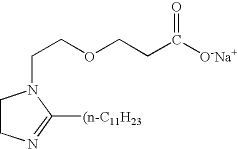

In another embodiment, the amphoteric compound is Amphoterge® K-2 from Lonza, having the following structure (referred to as coco imidazoline dicarboxylate; disodium cocoamphopropionate; or dinatrium-N-[2-(carboxylatomethoxy)ethyl]-N-[2-[(1-oxododecyl)amino]ethyl]glycinate; CAS no. 68298-20-4.)

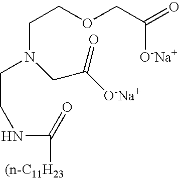

In another embodiment, the amphoteric compound is Amphoterge® KJ-2 from Lonza, having the following structure (referred to as disodium capryloamphopropionate; capric imidazoline dicarboxylate; or 1-[2-(carboxymethoxy)ethyl]-1-(carboxymethyl)-2-heptyl-4,5-dihydro-1H-imidazoliumhydroxide disodium salt (40% in Water); CAS no. 7702-01-4.) 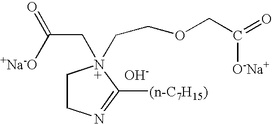
Formulations

The preservative compositions can be provided in a variety of formulations. Depending on their particular physical and/or chemical properties, the active compounds can be converted to the customary formulations which suit particular applications, such as solutions, emulsions, suspensions, powders, foams, pastes, granules, aerosols, very fine capsules in polymeric substances, as well as ULV cold mist and warn mist formulations.

The preservative compositions may be in dilute form or concentrated form. For example, the composition may be provided in concentrate form for dilution to a specific concentration for a particular application.

Additives

The composition may further include an additive such as a biocide, such as Na-triazoles, including propiconazole, tebuconazole, hexaconazole, cyproconazole, itraconazole, bromoconazole, epoxiconazole, metconazole, difenaconazole, triticaonazole, fenbuconazole, teraconazole and penconazole. More than one azole compound may be included.

One embodiment of the compositions may contain propiconazole or mixtures of azoles. The ratio of IPBC as the primary active ingredient to azole, or other active ingredient may vary according to the end use.

Additional active additives may include oxathiazines, for example (3-(benzo-[b]-thien-2-yl)-5,6-dihydro-1,4,2-oxathiazine 4-oxide, heavy metals such as copper, iron and zinc compounds, for example, copper oxide, Cu—HDO, and soaps or complexes thereof.

Other additives include quaternary ammonium compounds such as BAC and DDAC.

Other additives include amines including amine biocides.

Suitable additional fungicides include sodium Omadine or metal salts thereof, dichlofluanid, tolylfluanid, imazilil, isothiazolones chlorothalonil and carbendazim.

Na-omadine, or sodium omadine, also referred to as 1-hydroxy-2(1H)-pyridinethione, sodium salt, or by the trade names, sodium 2-pyridinethiol 1-oxide, sodium 2-mercaptopyridine, sodium 1-hydroxypyridine-2-thione, and omadine sodium, is a pyridine microbiocide, commercially available, e.g., from Arch Chemicals, Inc.

Propiconazole, or 1[[2-(2,4-dichlorophenyl)-4-propyl-1,3-dioxolan-2-yl]methyl]-1H-1,2,4-triazole, is a commercially available fungicide, also known as desmel, proconazole, tilt and wocosin.

Suitable insecticide additives may be used and may be selected depending upon the intended application and include for example, chlorpyrifos, pyrethroids (including cypermethrin, permethrin, deltamethrin and cyfluthrin), Chloronicotinyl insecticides such as imidacloprid and thiocloprid, pyroles and phenylpyrozoles such as chlorfenapyr, insect growth regulators such as fenoxycarb, chitin synthesis inhibitors, particularly the benzophenyl urea's such as diflubenzuron and also broad spectrum insecticides such as borates.

Other active agents that can be added include amine oxides, as disclosed in U.S. Pat. No. 6,375,727; and triazolopyrimidine derivatives as disclosed in U.S. Patent Application Publication No. 20020198222.

The composition may include other components that may act to improve the characteristics of the treated commodity. Such compounds include water repellents based on waxes, silicones or polysiloxanes, latex, fluorocarbon, organic carboxylates/metals, paper sizing agents or cross linking agents based on alky or acrylic resins, or mixtures thereof. Oils may also be used, including drying oils such as linseed oil or similar, as may UV absorbing compounds, free radical scavengers, UV stabilizing agents, corrosion inhibitors and defoamer, pigments or dyes.

The preservative compositions can be provided as formulations that include liquid solvents, liquefied gases under pressure, and/or solid carriers, optionally with the use of surface-active agents, that is, emulsifying agents and/or dispersing agents and/or foam-forming agents. In the case of the use of water as an extender, organic solvents such as, for example, alcohols, might, for example, also be used as auxiliary solvents. As liquid solvents, there are suitable in the main: aromatics, such as xylene, toluene or alkylnaphthalenes, chlorinated aromatics or chlorinated aliphatic hydrocarbons, such as chlorobenzenes, chloroethylenes such as 1,2-dichloroethane or methylene chloride, aliphatic hydrocarbons, such as cyclohexane or paraffins, for example benzine and other mineral oil fractions, alcohols, such as ethanol, isopropanol, butanol, benzyl alcohol or glycol as well as their ethers and esters, ketones, such as acetone, methyl ethyl ketone, methyl isobutyl ketone or cyclohexanone, strongly polar solvents, such as dimethylformamide and dimethyl sulphoxide, as well as water; by liquefied gaseous extenders or carriers are meant liquids which are gaseous at ambient temperature and under atmospheric pressure, for example aerosol propellants, such as halogenohydrocarbons as well as butane, propane, nitrogen and carbon dioxide; as solid carriers there are suitable: for example ground natural minerals, such as kaolins, clays, talc, chalk, quartz, attapulgite, montanorillonite or diatomaceous earth, and ground synthetic minerals, such as highly-disperse silica, alumina and silicates; as solid carriers for granules there are suitable: for example crushed and fractionated natural rocks such as calcite, marble, pumice, sepiolite and dolomite, as well as synthetic granules of inorganic and organic meals, and granules of organic material such as sawdust, coconut shells, maize cobs and tobacco stalks; as emulsifying and/or foam-forming agents there are suitable: for example non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates as well as albumen hydrolysis products; as dispersing agents there are suitable: for example lignin-sulphite waste liquors and methylcellulose.

Adhesives such as carboxymethylcellulose and natural and synthetic polymers in the form of powders, granules or latices, such as gum arabic, polyvinyl alcohol and polyvinyl acetate, as well as natural phospholipids, such as cephalins and lecithins, and synthetic phospholipids, can be used in the formulations. Other additives can be mineral and vegetable oils.

It is possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

The preservative compositions can include other active compounds such as fungicides, insecticides, acaricides and herbicides, and in mixtures with fertilisers and growth regulators.

The preservative compositions can be formulated as ready-for-use solutions, suspensions, wettable powders, pastes, soluble powders, dusting agents and granules. They are applied in the customary manner, for example by pouring, spraying, atomizing, scattering, dusting, foaming, brushing on and the like and may be presented in encapsulated or micro-encapsulated form. It is furthermore possible to apply the active compositions by the ultra-low-volume method or to inject the preservative compositions or the preservative compositions themselves into the substrate. The seed of the plant can also be treated.

The present invention includes pharmaceutical preparations that contain the preservative composition, in addition to non-toxic, inert, pharmaceutically suitable excipients, one or more pharmaceutically active compounds that can be used according to the invention or which consist of one or more other active substances that can be used according to the invention. For example, when used as agents for the protection of material, the preservative compositions according to the invention can also exist as a mixture with other known pharmaceutically active compounds. The following pharmaceutically active compounds may be mentioned by way of example: benzyl alcohol mono (or poly)hemiformal and other formaldehyde-releasing compounds, benzimidazolylmethyl carbamates, tetramethyldiuram disulphide, zinc salts of dialkyl dithiocarbamates, 2,4,5,6-tetrachloroisophthalonitrile, thiazolylbenzimidazole, mercaptobenzothiazole, organotin compounds, methylenebisthiocyanate, phenol derivatives such as 2-phenylphenol, (2,2,-dihydroxy-5,5,-dichloro)-diphenylmethane, 3-methyl-4-chlorophenol and 2-thiocyanatomethylthiobenzothiazole, N-trihalogenomethylthio compounds such as folpet, fluorofolpet and dichlofluanid, azole fungicides such as triadimefon, triadimenol, bitertanol, tebuconazole, propiconazole, azaconazole, isothiazolinone compounds such as kathon as well as quaternary ammonium compounds such as benzalkonium chloride. Mixtures of the substances to be used according to the invention with known insecticides can also be used. The following may be mentioned by way of example: organophosphorus compounds such as chloropyriphos or phoxim, carbamates such as aldicarb, carbosulphan or propoxur, or pyrethroids such as permethrin, cyfluthrin, cypermethrin, deltamethrin or fenvalerate.

The preservative compositions can include other suitable active components in the mixture such as algicides, molluscicides and active compounds against marine fouling organisms that cause fouling on the painted surfaces of ship's hull in contact with sea water.

In one embodiment, formulations can be prepared that contain about 0.0001 to 99% by weight of IPBC, or about 0.5 to 90%. The formulation may include about 0.0001 to 99% by weight of amphoteric compound. The formulations can be adjusted to the desired concentration of active components, additives and solvent.

The preservative composition is provided with, e.g., a betaine or amphoteric compound and IPBC in a ratio about 3:1 to 5:1.

Exemplary compositions having the following weight percents can be formulated as follows:

10-40% betaine;

2-10% IPBC; and

2-10% of a secondary active compound, such as a pharmaceutical or biocide, such as propiconazole.

The percentages can vary significantly depending upon the secondary active chosen. The amounts for a quaternary compound, e.g., would generally be more than an insecticide.

In a particular embodiment, preservative compositions are provided comprising a betaine and IPBC, as well as optionally an additional active component such as a biocide, such as propiconazole. The weight percent of the composition, is, for example:

10-40%, e.g., 20-40% betaine;

2-20%, e.g., 2-10%, or 4-8% IPBC; and

2-20%, e.g., 2-10%, or 2-6% of one or more another active agent, such as a biocide, for example propiconazole, depending on the activity of the active agent(s).

In another particular embodiment, preservative compositions are provided comprising a weak nitrogen amphoteric and IPBC, as well as optionally one or more other active agent, such as a biocide, for example propiconazole. The weight percent of the composition, is, for example:

5-60%, e.g., 10-40% or 20-40% or 8-20% of a weak nitrogen amphoteric;

2-20%, e.g., 2-10% or 4-8% IPBC; and

2-20%, e.g., 2-10%, or 2-6% of one or more another active agent, such as a biocide, for example propiconazole, depending on the activity of the active agent(s).

The concentrations of IPBC and other active components in the preservative compositions will depend on the species and the occurrence of the microorganisms to be combated, the composition of the material to be protected, and the choice of amphoteric compound. The optimum amount to be used can be determined by test series. Concentrations in one non-limiting embodiment may range from 0.001 to 5% by weight, or 0.05 to 1.0% by weight, relative to the material to be protected. For dilute solutions, the concentration of IPBC may be, e.g., 0.0001-1% by weight. The concentration of amphoteric compound may be e.g., from 0.0001-1% by weight, and the concentration of secondary biocide if present can be e.g. from 0.0001-1% by weight. In a more concentrated form, for example, for later dilution, the concentration of IPBC may be about 0.1-70% IPBC, e.g., 10-60% IPBC by weight. Optionally the concentration of amphoteric compound can be, e.g. 0.1-70% amphoteric compound, or, e.g., about 10-60% amphoteric compound by weight.

Powders or sprays and other vehicles can contain pharmaceutically active compound, or active compounds, in combination with the preservative composition, optionally including one or more other customary excipients(s), such as (a) bulking agents and extenders, for example starches, lactose, sucrose, glucose, mannitol and silica, (b) binders for example carboxymethylcellulose, alginates, gelatine and polyvinylpyrrolidone, (c) humectants, for example glycerol, (d) disintegrants, for example agar-agar, calcium carbonate and sodium bicarbonate, (e) solution retardants, for example paraffin, (f) resorption accelerators, for example quaternary ammonium compounds, (g) wetting agents, for example cetyl alcohol and glycerol monostearate, (h) absorbents, for example kaolin and bentonite, (i) gliding agents, for example talc, calcium stearate and magnesium stearate, and solid polyethylene glycols, or mixtures of the substances mentioned under (a) to (i).

Ointments, pastes, creams and gels and other vehicles can contain, besides the active compound(s) in combination with the preservative composition, the customary excipients such as animal and vegetable fats, waxes, paraffins, starches, tragacanth, cellulose derivatives, polyethylene glycols, silicones, bentonites, silica, talc and zinc oxide, or mixtures of these substances.

Powders and sprays can contain, besides the active compound(s) in combination with the preservative composition, the customary excipients, for example lactose, talc, silica, aluminium hydroxide, calcium silicate and polyamide powder, or mixtures of these substances, and sprays can additionally contain the customary propellants, for example chlorofluorohydrocarbons.

Solutions and emulsions can contain, beside the active compound(s) in combination with the preservative composition, the customary excipients such as solvents, solution retardants and emulsifiers, for example water, ethyl alcohol, isopropyl alcohol, ethyl carbonate, ethyl acetate, benzyl alcohol, benzyl benzoate, propylene glycol, 1,3-butylene glycol, dimethylformamide, oils, in particular cotton seed oil, groundnut oil, maize germ oil, olive oil, castor oil and sesame seed oil, glycerol, glycerol formal, tetrahydrofurfuryl alcohol, polyethylene glycol and fatty acid ester of sorbitan, or mixtures of these substances.

The compositions can also exist in sterile form.

Suspensions can contain, besides the pharmaceutically active compound(s) in combination with the preservative composition, the customary excipients such as liquid diluents, for example water, ethyl alcohol, propyl alcohol, suspending agents, for example ethoxylated isostearyl alcohols, polyoxyethylene sorbitol esters and polyoxyethylene sorbitan esters, microcrystalline cellulose, aluminium metahydroxide, bentonite, agar-agar and tragacanth, or mixtures of these substances.

The said formulation forms can also contain colorants, preservatives and odor- and flavor-improving additives, for example peppermint oil and eucalyptus oil, and sweeteners; for example saccharine.

In general, the preservative compositions in pharmaceutical preparations can be e.g., present in a concentration of approx. 0.1 to 99.5% by weight, or 0.5 to 95% by weight, of the total mixture. In particular, the preservative can be in dilute or concentrated form. For example, in dilute form, the concentration of IPBC may be about 0.0001 to 1%, while in concentrated form, the concentration of IPBC may be, e.g. from 1-70% by weight.

The abovementioned pharmaceutical preparations are prepared in the customary manner by known methods, for example by mixing the preservative composition with the active compound(s) optionally with an excipient or excipients.

The pharmaceutically active compound(s) in combination with the preservative composition, as pharmaceutical preparations can be administered, e.g., topically.

Exemplary Uses of the Compositions

Preservative compositions comprising the compounds according to the present invention may have a wide range of utility for protecting against or controlling microorganisms from a wide variety of classes including fungi, bacteria, algae, viruses and yeasts. Some of the preferred utilities of the compositions are to protect wood, paint, adhesive, glue, paper, textile, leather, plastics, cardboard, lubricants, including metal working fluids cosmetics, caulking, and industrial cooling water from microorganisms.

The active compounds according to the invention can have a powerful action against pests and can be employed in practice for combating undesirable harmful organisms. The active substances can be suitable, inter alia, for use as plant protection agents, such as fungicides.

Fungicidal agents in plant protection can be employed for combating Plasmodiophoromycetes, Oomycetes, Chytridiomycetes, Zygomycetes, Ascomycetes, Basidiomycetes and Deuteromycetes.

Some causative organisms of fungal diseases which come under the generic names listed above may be mentioned as examples, but not by way of limitation:

Pythium species, such as Pythium ultimum;

Phytophthora species, such as Phytophthora infestans;

Pseudoperonospora species, including Pseudoperonospora humuli or Pseudoperonospora cubensis;

Plasmopara species, such as Plasmopara viticola;

Peronospora species, such as Peronospora pisi or P. brassicae;

Erysiphe species, such as Erysiphe graminis;

Sphaerotheca species, for example, Sphaerotheca fuliginea;

Podosphaera species, for example, Podosphaera leucotricha;

Venturia species, for example, Venturia inaequalis;

Pyrenophora species, for example, Pyrenophora teres or P. graminea (conidia form: Drechslera, syn: Helminthosporium);

Cochliobolus species, for example, Cochliobolus sativus (conidia form: Drechslera, syn: Helminthosporium);

Uromyces species, for example, Uromyces appendiculatus

Puccinia species, for example, Puccinia recondita;

Tilletia species, for example, Tilletia caries;

Ustilago species, for example, Ustilago nuda or Ustilago avenae;

Pellicularia species, for example, Pellicularia sasakii;

Pyricularia species, for example, Pyricularia oryzae;

Fusarium species, for example, Fusarium culmorum;

Botrytis species, for example, Botrytis cinerea; Septoria species, such as Septoria nodorum; Leptosphaeria species, such as, Leptosphaeria nodorum;

Cercospora species, for example, Cercospora canescens;

Altentaria species, for example, Alternaria brassicae

Pseudocercosporella species, for example, Pseudocercosporella herpotrichoides.

The toleration, by plants, of the preservative compositions, at the concentrations required for combating plant diseases, may permit treatment of above-ground parts of plants, of vegetative propagation stock and seeds, and of the soil

In this context, the preservative compositions according to the invention may be used for combating cereal diseases such as, for example, against the causative organism of powdery mildew of cereals (Erysiphe graminis) or against the causative organism of net blotch of barley (Pyrenophora teres) or against the causative organism of foot rot of barley or wheat (Cochliobolus sativus) or against the causative organism of leaf spot of wheat (Leptosphaeria nodorum) or for combating diseases in fruit and vegetable growing such as, for example, against the causative organism of apple scab (Venturia inaequalis) or against Oomycetes or for combating rice diseases such as, for example, the causative organism of rice blast disease (Pyricularia oryzae) or against the causative organism of rice stem blight (Pellicularia sasakii). Further, the preservative compositions according to the invention may have broad in vitro activity.

Besides the above-mentioned activity against cytopathogenic microorganisms, the preservative compositions according to the invention may be useful as microbicidals, e.g., against a broad range of microorganisms that are relevant for the protection of materials.

Insofar, the preservative compositions according to the invention may be particularly suitable for the protection of industrial materials.

In one embodiment, the industrial materials in this context are non-live materials which have been prepared for use in industry. For example, industrial materials which are to be protected by preservative compositions according to the invention from microbial change or destruction can be glues, sizes, paper and board, textiles, leather, wood, paints and plastic articles, cooling lubricants and other materials which can be attacked or decomposed by microorganisms. Parts of production plants, for example cooling-water circuits, which may be impaired by the multiplication of microorganisms may also be mentioned within the scope of the materials to be protected. Industrial materials which may be mentioned within the scope of the present invention are e.g., glues, sizes, papers and boards, leather, wood, paints, plastic articles, cooling lubricants and cooling circuits. Microorganisms, capable of degradation or change of the industrial materials, which may be mentioned are, for example, bacteria, fungi, yeasts, algae and slime organisms. The preservative compositions according to the invention can act against fungi, in particular stain and mould fungi, wood-discoloring and wood-destroying fungi (Basidiomycetes), and against algae and bacteria.

Microorganisms of the following genera may be mentioned as examples:

Alternaria, such as Alternaria tenuis,

Aspergillus, such as Aspergillus niger,

Chaetomium, such as Chaetomium globosum,

Coniophora, such as Coniophora puteana,

Lentinus, such as Lentinus tigrinus,

Penicillium, such as Penicillium glaucum,

Polyporus, such as Polyporus versicolor,

Aureobasidium, such as Aureobasidium pullulans,

Sclerophoma, such as Sclerophoma pityophila,

Trichoderma, such as Trichoderma viride,

Escherichia, such as Escherichia coli,

Pseudomonas, such as Pseudomonas aeruginosa,

Staphylococcus, such as Staphylococcus aureus,

Stachybotrys, such as Stachybotrys chartarum, and

Malassezia, such as Malassezia furfur.

In addition, the compositions of the present invention may exhibit good antimicrobial, in particular good antimycotic, actions. They may have a broad antimycotic spectrum of action, in particular against dermatophytes and yeasts as well as biphasic fungi, for example against Candida species such as Candida albicans, Epidermophyton species, such as Epidermophyten floccossum, Aspergillus species, such as Aspergillus niger and Aspergillus fumigatus, Trichophyton species, such as Trichophyton mentagrophytes, Microsporon species, such as Microsporon felineum, and against Torulopsis species such as Torulopsis glabrata. The enumeration of these microorganisms in no case represents a restriction of the microorganisms which can be combated, but has illustrating character only.

The following may be mentioned as examples for indications in human medicine: dermatomycoses and systemic mycoses caused by Trichophyton mentagrophytes and other Trichophyton species, Microsporon species as well as Epidermophyton floccosum, yeasts and biphasic fungi as well as moulds.

The following may be mentioned as examples of indications in veterinary medicine: all dermatomycoses and systemic mycoses, in particular those caused by the abovementioned causative organisms.

The following lists specific industries and applications of the compounds or compositions:

| Industry | Application |
|---|---|
| Adhesives, sealants | adhesives |
| | caulks |
| | sealants |
| Agriculture/food chain | adjuvant preservation |
| | agricultural active ingredient |
| | agricultural chemical |
| | preservative |
| | agricultural formulations |
| | preservation |
| | animal feed preservation |
| | dairy chemicals |
| | fertilizer preservation |
| | food preservation |
| | food processing chemicals |
| | grain preservation |
| | post-harvest produce protection |
| | sugar processing |
| | tobacco |
| Construction products | asphalt/concrete |
| | cement modifiers |
| | cementaceous surfaces |
| | construction products |
| | roof mastics |
| | stone |
| | synthetic stucco |
| | wall mastics |
| | joint cement |
| Cosmetics and toiletries | cosmetics |
| | raw materials for toiletries |
| | toiletries |
| | raw materials for toiletries |
| Cosmetics and toiletries | creams (e.g. anti-wrinkle creams with vitamin B or |
| | retinol) |
| | shaving creams |
| | skin care products |
| | lotions |
| Disinfectants, antiseptics | antiseptic |
| | disinfectant |
| Emulsions, dispersions | aqueous dispersions |
| | dispersed pigments |
| | latex |
| | photographic emulsions |
| | pigment slurries |
| | polymer lactices |
| Formulated consumer & | air fresheners |
| industrial products | fabric softeners |
| | hand cleaners |
| | polishes, floor, furniture, shoe |
| | sponges & towelettes |
| | spray strach |
| | waxes |
| Industrial processing, misc | dry cleaning fluids preservation |
| | electrodeposition paint, baths, rinses. |
| | electrodeposition pre-treatment, post rinses |
| | industrial fluids preservation |
| | pasteurization baths |
| | process aid preservation |
| Industrial water treatment | air washers |
| | cooling towers |
| | cooling water |
| | water cooling |
| Laundry | household laundry products |
| | laundered goods |
| Laundry | laundry rinse water |
| | pre-washers |
| | sanitizers-laundry |
| | removers, spot & stain |
| Leather, leather products | leather and hide |
| | leather and hide products |
| Lubricants, hydraulic aids | automotive lubricants and fluids |
| | conveyor lubricants |
| | greases |
| | hydraulic fluids |
| | hydraulic oils |
| | lubricants |
| Medical devices | diagnostic enzymes |
| | diagnostic kits |
| | medical devices |
| Metalworking & related app's | cutting fluids |
| | metal cleaning |
| | metalworking fluids |
| Odor control (active ingredient) | air conditioning |
| | animal bedding |
| | cat litter |
| | chemical toilet preparations |
| | deodorizers |
| | humidifiers |
| | industrial deodorants |
| | sanitary formulations |
| | toilet bowls |
| Paints and coatings | coating emulsions |
| | Paints, latex and non-latex |
| Paper and wood pulp, their | absorbant materials of paper and wood pulp |
| products | packaging materials of paper and wood pulp |
| | paper and cardboard |
| | paper products |
| | paper treatment |
| | soap wrap |
| | wood preservation |
| | wood pulp |
| | wood pulp products |
| Paper mill | paper mill slimicides |
| | pulp and paper slurries |
| Petroleum refining, fuels | aviation fuels (jet fuel, aviation gas) |
| | burner, diesel and turbine fuel |
| | oils |
| | coal slurries |
| | cooling lubricants |
| | diesel fuel additives |
| | diesel fuels |
| | fuels |
| | gasoline |
| | heating oils |
| | hydrocarbons |
| | kerosene |
| | liquefied petroleum gas |
| | petrochemical feedstocks |
| | petroleum products storage, transportation and |
| | production |
| | recycled petroleum products |
| | residual fuel oils |
| | turbine oils |
| Pharmaceutical | topical antifungal and antibacterial |
| | topically applied preparations and medicaments |
| Photographic chemicals and | photographic processing - wash water, rinses |
| process | photoplate processing chemicals (developers, |
| | stabilizers etc) |
| Printing | fountain solutions (printing) |
| | ink components (pigments, rinses, solvents, etc) |
| | inks |
| Sanitizers (active) | sanitizers |
| | sanitizers-dairy |
| | sanitizers-dental |
| | sanitizers-fermentation |
| | sanitizers-food preparation |
| | sanitizers-food processing |
| | sanitizers-medical |
| | sanitizers-rendering |
| | sanitizers-veterinary |
| Soaps, detergents, cleaners | cleaners |
| | hard surface cleaners |
| | detergents, hand automatic laundry, other |
| | fabric softeners |
| | household cleaners |
| | industrial cleaners |
| | liquid soaps, hand, dish, laundry |
| | oil and grease remover |
| | powdered soaps |
| | raw materials for cleaning products |
| | soaps |
| | shampoos |
| | surfactants |
| Textiles, textile products | bonded fabrics |
| | burlap |
| | canvas |
| | canvas goods |
| | canvas backing |
| | carpets |
| | clothing |
| | coated fabrics |
| | curtains |
| | draperies |
| | engineering textiles |
| | fibers |
| | geotextiles |
| | goods made of textiles |
| | knitted fabrics |
| | nets |
| | nonwoven fabrics |
| | rope and cord |
| | rugs |
| | textile accessories |
| | textile products |
| | textiles |
| | upholstery |
| | woven fabrics |
| | yarn |
| Textile processing | dye fixatives |
| | dyes |
| | fiber lubricants |
| | hand modifiers |
| | sizes |
| | textile processing fluids |
| Therapeutic (active or | animal health/veterinary |
| preservative) | aquaculture |
| | dental |
| | human health |
| | pharmaceutical/therapeutic |
| Water purification | charcoal beds |
| | deionization resins |
| | filters |
| | membranes |
| | reverse osmosis membranes |
| | ultrafilters |
| | water purification |
| | water purification pipes, tubing |
| Wood applications | lazures (wood stains) |
| | wood |
| | wood products |
| Miscellaneous | alcohols |
| | bedding incorporating water or gels |
| | ceramic |
| | contact lens cases-leaching |
| | electronic circuitry |
| | electronics chemicals |
| | enzymes-food production |
| | enzymes-industrial |
| | gel cushions |
| | laboratory reagents |
| | marine antifoulants |
| | mildewcides |
| | mining applications |
| | natural rubber latex |
| | oil field applications |
| | pipes |
| | plastics |
| | products made of plastic |
| | polymer systems |
| | polymers and resins (synthetic and natural) |
| | reagent preservation |
| | rubber |
| | rubber products |
| | skin remover |
| | solid protective/decorative |
| | films |
| | swimming pools |
| | waste treatment |
| | water beds |

Treatment of Surfaces in a Variety of Applications

In one embodiment, preservative methods and compositions are provided for treating materials such as cellulosic materials including wood.

In the embodiment where wood is treated, the compositions and methods can provide enhanced sapstain resistance while also providing effective resistance to mold, mildew, soft rot, brown rot and white rot. The preservative compositions may be applied to any wood substrate, such as any hardwood or softwood. Hardwood, softwood

For example, for preventing or controlling sapstain and mold, the wood preservative composition is applied to green wood. The term “green” as used herein is defined as freshly cut, unseasoned, or the like. Examples of suitable wood substrates include, but are not limited to, maple, oak, birch, cherry, fir, and the like. The wood preservative composition may be applied to any wood substrate that is for example to be pressure treated. The wood substrate may be a soft wood, such as a pine, fir, or hemlock. Suitable pine wood substrates include, but are not limited to, southern yellow pine and ponderosa pine.

Wood or other material may be treated with the disclosed compositions. Further materials that can be treated include cellulosic materials such as cotton, as well as leather, textile materials, synthetic fibres, Hessian, rope, and cordage.

The compounds and compositions may also be applied as an additive to paints and similar materials that are susceptible to fungal degrade. Other materials include metal working fluids where stability of active ingredients and particularly IPBC can be a problem resulting in fungal infestation.

Another embodiment is a method of controlling microorganisms, such as fungi and sapstain organisms, on and/or in a wood substrate comprising applying a biocidally effective amount of the wood preservative composition to the wood substrate. The term “controlling” as used herein includes, but is not limited to, inhibiting the growth of microorganisms, such as fungi and sapstain organisms. Non-limiting examples of fungi are Trametes versicolor (T. versicolor), Gloeophyllum trabeum (G. trabeum), Poria placenta (P. placenta), Lentinus lepideus (L. lepideus), Coniophora puteana (C. puteana), and Chaetomium globsum (C. globsum).

Methods of Application of the Composition to Materials Such as Wood

The compositions of the present invention may be applied to the wood or other substrate to be treated, by means well known to those skilled in the art. The material may be applied to, e.g., wood, for example, by dipping, brushing, spraying or pressure impregnation. This applies to either solid substrates, but also composite materials, for example, wood composites, or wood-plastic composites.

In one embodiment, the concentrate is diluted to working solution strength by addition of water. The concentrate is diluted from about 15 to 300 times with water depending on the severity of the environmental conditions and the length of protection desired. If desired, buffers, water repellents and other additives may be added to the treating solution. Historical buffers or anticorrosives, such as borax or soda ash may be added as well as iron chelating compounds such as phosphoric acid and phosphonic acid. Insecticides as well as dyes, pigments, resins and water repellents may be added, if desired.

The preservative compositions can be prepared, for example, as solutions or emulsions by conventional means using water or organic solvents or mixed together.

One embodiment is to combine a water solution of betaine compound or amphoteric compound with an organic solvent solution of IPBC to create an emulsion. The betaine compound or amphoteric compound can act as a surfactant to emulsify the IPBC solution. The resulting emulsion is diluted with water and, can be applied to wood by conventional treating methods such as immersion, brush, spray or pressure.

The quantity and ratio of amphoteric compound to IPBC will depend upon the specific application. The ratio of amphoteric compound (betaine or weak nitrogen amphoteric) to IPBC is, e.g.:

80:1-1:20;

20:1-1:10; or

3:1-5:1.

Typical solvents include combinations of water, aromatic solvents, polar solvents and aliphatic solvents. It may be advantageous to supply the preservative composition in concentrated form with about 20 to 40 percent by weight solvent with the remaining solvent being added prior to use.

Optionally, a water solution of the amphoteric compound or betaine compound is combined with an organic solvent solution of 3-iodo-2-propynyl butyl carbanate to create an emulsion.

If desired, the wood preservative composition may incorporate other additives such as azole fungicides and insecticides. In general, for control of sapstain in green lumber the preferred methods of application are by dipping or spraying. For lumber which will be utilized in more severe environments, pressure treatment is a preferred method of application.

There are a wide variety of processes available for the application of preservatives to wood products. These are generally divided into two areas based on the ‘result’ of treatment; superficial application processes and penetrating processes. Standard tests are known in the industry.

The following examples will serve to illustrate the invention. All parts and percentages in said examples and elsewhere in the specification and claims are by weight unless otherwise indicated.

### EXAMPLES

### Example 1

### Betaine Formulations

Water-based formulations, oil in water emulsions or micro-emulsions can be prepared using methods available in the art These can be manufactured as concentrates that are diluted into water at room temperature with sufficient agitation to ensure proper dispersion. For example, formulations can be prepared directly in organic solvents or oils either as concentrated formulations or diluted solutions containing the appropriate amount of components including, e.g., a selected betaine compound.

Formulations are prepared in solvent and aqueous based systems by mixing together the components as listed below in the Tables. The formulations can be used for application to a variety of surfaces, such as wood for stain control. The formulations are prepared with IPBC or IPBC-propiconazole and a betaine ester.

Formulations prepared with IPBC and a betaine are shown below in Table 1.

TABLE 1

| | Formulation-1 | Formulation-2 | Formulation-3 |
|---|---|---|---|
| INGREDIENTS | [wt. %] | [wt. %] | [wt. %] |
| Omacide IPBC | 6.0 | 6.0 | 12.0 |
| (3-iodo-2-propynyl- | | | |
| butylcarbamate) | | | |
| 97-100% | | | |
| (Arch Chemicals) | | | |
| Laurylbetaine or | 40.0 | 20.0 | — |
| N-dodecyl-N,N- | | | |
| dimethylbetaine) | | | |
| (Lonza group) | | | |
| N,N-dimethyl-N- | — | 20.0 | — |
| haxadecylamino- | | | |
| acetic acid | | | |
| (Lonza Group) | | | |
| Poly-ethoxylated- | 25.0 | 25.0 | 55.0 |
| nonylphenols | | | |
| or glycols, | | | |
| linear or branched | | | |
| (Rhodia) | | | |
| Antifoams | 4.0 | 4.0 | 4.0 |
| Dimethylpolysiloxane | | | |
| or Polysiloxane | | | |
| oil in water | | | |
| (Taylor Chemical Co.) | | | |
| DI Water | 25.0 | 25.0 | 29.0 |
| Total | 100.0 | 100.0 | 100.0 |

Omacide IPBC (99% a.i.) is commercially available, e.g., from Arch Chemicals. Lonzaine 12 S (a laurylbetaine formulation) and Lonzaine 16SP (a N,N-Dimethyl-N-hexadecylaminoacetic acid formulation) are commercially available from Lonza group.

The glycol is, e.g., a poly-ethoxylated nonylphenol or glycol that is linear or branched commercially available, for example, from Rhodia. The antifoam is, e.g., a dimethylpolysiloxane or a polysiloxane oil in water commercially available, e.g., from Taylor Chemical Co.

Formulations including IPBC-Propiconazole and a betaine ester are shown below in Table 2.

TABLE 2

| | Formulation-4 | Formulation-5 | Formulation-6 |
|---|---|---|---|
| Compounds | [wt. %] | [wt. %] | [wt. %] |
| Omacide IPBC | — | 6.0 | 5.0 |
| (3-iodo-2-propynyl-butylcarbamate) | | | |
| 97-100 wt. % | | | |
| (Arch Chemicals) | | | |
| Omacide ® IPBC - industrial fungicide | 17.0 | — | — |
| (3-iodo-2-propynyl-butylcarbamate) | | | |
| 40-42 wt. % | | | |
| (Arch Chemicals) | | | |
| Wocosin 50 TK or | 10.0 | 8.0 | 10.0 |
| 1-[[2-(2,4-dichlorophenyl)-4-propyl-1,3- | | | |
| dioxolan-2-yl]-methyl]-1H- | | | |
| 1,2,4-triazole or | | | |
| Propiconazole 50 wt. % a.i. | | | |
| (Janssen Pharmaceutical) | | | |
| Laurylbetaine or | — | 40.0 | 20.0 |
| N-dodecyl-N,N-dimethylbetaine) | | | |
| (Lonza group) | | | |
| Cetyl betain or | 50.0 | — | 20.0 |
| N,N-Dimethyl-N-hexadecylamino- | | | |
| acetic acid (Lonzaine 16SP) | | | |
| (Lonza group) | | | |
| Mixture of poly-ethoxylated- | 5.0 | 30.0 | 30.0 |
| nonylphenols or glycols, linear/branched | | | |
| (Rhodia) | | | |
| Antifoams | 2.0 | 4.0 | 4.0 |
| Dimethylpolysiloxane or Polysiloxane oil | | | |
| in water | | | |
| (Taylor Chemical Co.) | | | |
| Isopropanol | 10.0 | — | — |
| or 2-propanol | | | |
| DI Water | 6.0 | 12.0 | 11.0 |
| Total | 100.0 | 100.0 | 100.0 |

Omacide IPBC (40% a.i.) is commercially available, e.g., from Arch Chemicals. Wocosin 50 (Wocosin 50 TK or 1-[[2-(2,4-dichlorophenyl)-4-propyl-1,3-dioxolan-2-yl]-methyl]-1H-1,2,4-triazole, propiconazole, 50 wt % a.i.) is commercially available from Janssen Pharmaceutical.

In Table 2, the glycol is, e.g., a poly-ethoxylated nonylphenol or glycol that is linear or branched that is commercially available, for example, from Rhodia. The antifoam is, e.g., a dimethylpolysiloxane or a polysiloxane oil in water commercially available, e.g., from Taylor Chemical Co.

As indicated in Table 2, Formulation 4 is a solvent-based formulation, while the other formulations in the Table are water-based formulations.

### Example 2

### Amphoteric Formulations

Formulations including amphoteric compounds also can be prepared using methods available in the art. Typically, the components are simply mixed together to prepare the formulations

Amphoteric surfactant compounds that can be used in the formulations include disodium-caproamphodipropionates or dodecyldimethylbetains. For example, formulations can include Amphoterge KJ-2 in combination with IPBC or IPBC-propiconazole, with or without a betaine compound.

The exemplary formulations shown below in Table 3 are prepared.

TABLE 3

| | Formulation 7 | Formulation 8 |
|---|---|---|
| COMPONENTS | [wt %] | [wt %] |
| Omacide IPBC | 6.0 | 6.0 |
| (3-iodo-2-propynyl- | | |
| butylcarbamate) | | |
| 97-100% | | |
| (Arch Chemicals) | | |
| Wocosin 50 TK or | 8.0 | 8.0 |
| 1-[[2-(2,4-dichlorophenyl)-4- | | |
| propyl-1,3-dioxolan-2-yl]- | | |
| methyl]-1H-1,2,4-triazole | | |
| propiconazole 50 wt. % a.i. | | |
| (Janssen Pharmaceutical) | | |
| Disodium | 20.0 | 10.0 |
| Caproamphodipropionate and | | |
| Capryloamphodipropionate | | |
| Amphoterge KJ-2 (Lonza group) | | |
| Laurylbetaine or | — | 10.0 |
| N-dodecyl-N,N-dimethylbetaine) | | |
| (Lonza group) | | |
| Poly-ethoxylated-nonylphenols | 30.0 | 30.0 |
| or glycols, linear or branched | | |
| (Rhodia) | | |
| Antifoams | 4.0 | 4.0 |
| Dimethylpolysiloxane or | | |
| Polysiloxane oil in water | | |
| (Taylor Chemical Co.) | | |
| DI Water | 32.0 | 32.0 |
| Total | 100.0 | 100.0 |

### Example 3

### Stability Studies

The stability of IPBC formulations was examined. Testing demonstrated the surprising improvement in the stability of IPBC when formulated using the methods disclosed herein. The tests were performed by preparing concentrated formulations which were then stored at elevated temperature (40° C.) under laboratory conditions, for a period of time up to 44 days.

Samples were taken from the freshly prepared concentrate and analysed to give a zero-time data point. Thereafter, the solutions were analysed to determine the residual levels of IPBC and other active ingredients after specific storage periods, and compared with the initial value to determine the loss of active ingredient. Results were compared with typical formulations from commercially available formulations.

The results of the stability study using IPBC in various formulations is shown below in Table 4.

TABLE 4

| | Initial | | 44 days | | Changes | |
|---|---|---|---|---|---|---|
| | IPBC | Prop. | IPBC | Prop. | IPBC | Prop. |
| Formula | [wt. %] | | [wt. %] | | [% decomposition] | |
| IPBC/Prop | 5.24 | 3.66 | 5.38 | 3.92 | 0.0 | 0.0 |
| Amphoterge KJ-2 | | | | | | |
| IPBC/Prop | 6.10 | 3.89 | 5.79 | 4.14 | 4.9 | 0.0 |
| betaine 12S | | | | | | |
| IPBC/Prop | 6.05 | 4.33 | 6.00 | 4.36 | 0.8 | 0.0 |
| betaine 16SP | | | | | | |
| IPBC/Prop/Betain | 7.26 | 5.30 | 7.34 | 5.51 | 0.0 | 0.0 |
| 16SP | | | | | | |
| Solvent-based | | | | | | |
| IPBC/betaine 12S | 6.12 | — | 6.19 | — | 0.0 | — |
| IPBC/DDAC | 7.90 | — | 3.67 | — | 53.54 | — |
| IPBC/BAC | 2.25 | — | 1.47 | — | 34.67 | — |
| IPBC/amineoxide | 6.00 | — | <1.0 | — | ˜90.0 | — |

where:

IPBC is Omacide IPBC or 3-iodo-2-propynyl-butylcarbamate, 97-100% (Arch Chemicals);

Ampherterge KJ-2 is disodium capryloamphopropionate, or 1-[2-(carboxymethoxy)ethyl]-1-(carboxymethyl)-2-heptyl-4,5-dihydro-1H-immidazoliumhydroxide disodium, available from Lonza Group Ltd, Switzerland.

Prop is Propiconazole or Wocosin 50 TK or 1-[[2-(2,4-dichlorophenyl)-4-propyl-1,3-dioxolan-2-yl]-methyl]-1H-1,2,4-triazole or propiconazole 50 wt. % a.i. (Janssen Pharmaceutical);

Betain 12S is Lauryl-Dimethyl Betaine or N-dodecyl-N,N-dimethyl Betaine (Lonza group);

Betain 16SP is Cetyl Betain or N,N-Dimethyl-N-Hexadecylamino-Acetic acid (Lonza Group);

BAC is Alkyl-Dimethyl-benzyl-ammonium chloride or BTC 8358 (Stepan);

DDAC is N,N-Didecyl-N,N-Dimethylammonium chloride or Bardac 2280 (Lonza Group); and

Amineoxides is N-Hexadecyl-Dimethylamine oxide or Barlox 16S. (Lonza Group).

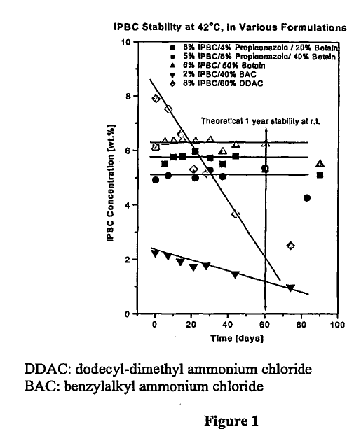

The results in Table 4 are also shown graphically in FIG. 1.

All the formulations, solvent or water-based, using the betaine surfactant systems (Lonzaine 12S or 16SP), showed good IPBC stability, whereas other systems, based on quats (DDAC, DDAP, BAC) or amine-oxides, exhibited significant IPBC instability. These results clearly demonstrate the improvement in the stability of IPBC in the presence of an amphoteric surfactant compound. Combinations of IPBC and betaine or IPBC/propiconazole betaine show little or no degradation of IPBC over the 44-day test period. In contrast, IPBC formulated together with typical surfactants such as benzyl ammonium chloride (BAC) or didecyl-dimethyl ammonium chloride (DDAC) or amine oxide, show significant losses of the active ingredient IPBC over the 44-day storage period. These losses can have a significant impact on the performance of such compositions when applied to substrates. These studies demonstrated the formation of stable, and highly active formulations with improved properties.

Whereas particular embodiments of the invention have been described herein, for purposes of illustration, it will be evident to those skilled in the art that numerous variations of the details may be made without departing from the invention as defined in the appended claims.

What is claimed is:

1. A preservative composition comprising an amphoteric compound and 3-iodo-2-propynyl butyl carbamate, wherein the amphoteric compound is a betaine.

2. The composition of claim 1, wherein the betaine is a carboxy betaine.

3. The composition of claim 1 or 2, wherein the ratio of betaine:3-iodo-2-propynyl butyl carbamate in the composition is about 0.5:1 to about 20:1 betaine:3-iodo-2-propynyl butyl carbamate by weight.

4. The composition of any one of claims 1-3, wherein the betaine is selected from the group consisting of coco amido propyl dimethyl betaine; cetyl betaine((carboxylatomethyl)hexadecyldimethylammonium); and coco amido propyl dimethyl sultaine (cocoamidopropyl-N,N-dimethyl-N-2-hydroxypropyl sulfobetaine).

5. The composition of any one of claims 1-3, wherein the betaine is of the formula
R—N⁺(CH₃)₂—CH₂—COO⁻; or
R—C(═O)N⁺(CH₃)₂—CH₂—COO⁻
or a salt thereof;
wherein R is a straight chain C₈₋₂₄ alkyl group, a straight chain C₁₀₋₁₈ alkyl group, or a C₁₂₋₁₆ alkyl group.

6. The composition of any one of claims 1-3, wherein the betaine is a cocamidopropyl-betaine of formula:
RC(O)NH(CH₂)₃—N⁺(CH₃)₂—CH₂—COO⁻;
wherein R is a C₉ to C₁₃ straight chain alkyl group.

7. A preservative composition comprising an amphoteric compound and 3-iodo-2-propynyl butyl carbamate, wherein the amphoteric compound is a weak nitrogen amphoteric.

8. The composition of claim 7, wherein the weak nitrogen amphoteric is an imidazoline amphoteric.

9. The composition of claim 7, wherein the ratio of weak nitrogen amphoteric compound to 3-iodo-2-propynyl butyl carbamate in the composition is about 0.5:1 to 20:1 by weight.

10. The composition of claim 7, wherein the weak nitrogen amphoteric is selected from the group consisting of
cocoamphodiacetate,
cocoamphoacetate,
cocoamphopropionate,
cocoamphodipropionate,
cocoamphohydroxypropylsulfonate,
cocoimidopropionate,
octoimidopropionate, and
capryloamphodipropionate
or salt thereof.

11. The composition of claim 7, wherein the weak nitrogen amphoteric is selected from the group consisting of
cocoiminoglycinate,
cocoamphocarboxyglycinate, and
tallowamphopolycarboxyglycinate,
or salt thereof.

12. The composition of claim 7, wherein the weak nitrogen amphoteric is selected from the group consisting of a
C₈ alkylamphopropionate,
C₁₂₋₁₈ alkylamphopropionate, and
C₁₂ alkyliminodipropionate,
or salt thereof.

13. The composition of claim 7, wherein the weak nitrogen amphoteric is a compound of the formula: 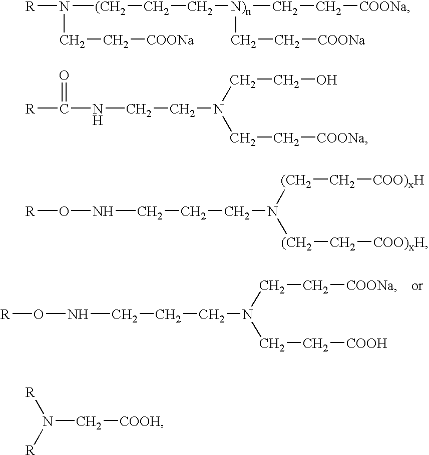
wherein each R is independently a C₈₋₂₄ alkyl; each R¹ is H or a metal cation, each n is independently 0-5; and each x is independently 0-5.

14. The preservative composition of any one of claims 1-13, further comprising an additive.

15. The composition of claim 14, wherein the additive is a biocide.

16. The composition of claim 14, wherein the additive is propiconazole.

17. The composition of any one of claims 1-16 further comprising an antifoam agent.

18. The composition of claim any one of claims 1-17, wherein the composition is within a personal care product.

19. The composition of any one of claims 1-17, wherein the composition is within a household product or industrial product.

20. The composition of any one of claims 1-17, wherein the composition is a wood preservative.

21. The composition of any one of claims 1-17, having the property of providing stain resistance to wood.

22. The composition of claim 1, wherein the ratio of betaine:3-iodo-2-propynyl butyl carbamate (IPBC) is about 3:1 to 5:1; and wherein the composition includes propiconazole, wherein the ratio of IPBC to propiconazole in the composition is about 4:1 to 1:1 by weight.

23. The composition of claim 22, wherein the ratio of betaine:IPBC is about 4:1 and the ratio of propiconazole:IPBC is about 1:1 by weight.

24. A method of preserving a material comprising applying the composition of any of claims 1-23 to the material, or combining the composition of any one of claims 1-23 with the material.

25. The method of claim 24, wherein the method comprising applying or combining an effective amount of the composition to inhibit the growth of microorganisms.

26. The method of claim 25, wherein the microorganism is a fungus or a bacteria.

27. The method of claim 24, wherein the material is a personal care product.

28. The method of claim 24, wherein the material is a household product or industrial material.

29. The method of claim 24, wherein the material is cellulosic.

30. The method of claim 24, wherein the material comprises wood.

31. The method of claim 30, wherein the method comprises applying the composition to the wood in an effective amount to improve the stain resistance of the wood.

32. A wood product comprising a wood treated with a preservative formulation of any one of claims 1-23.
